(19) United States
(12) Patent Application Publication
(10) Pub. No.: US 2024/0153185 A1
(43) Pub. Date: May 9, 2024

(54) SYSTEM AND METHOD FOR ANIMATING SECONDARY FEATURES

(71) Applicant: Lucio Dorneles MOSER, Vancouver (CA)

(72) Inventor: Lucio Dorneles MOSER, Vancouver (CA)

(73) Assignee: Digital Domain Virtual Human (US), Inc., Los Angeles, CA (US)

(21) Appl. No.: 18/410,755

(22) Filed: Jan. 11, 2024

Related U.S. Application Data
(63) Continuation of application No. PCT/CA2022/051156, filed on Jul. 27, 2022.
(60) Provisional application No. 63/227,333, filed on Jul. 29, 2021.

(51) Int. Cl. G06T 13/40; G06F 17/16

(52) U.S. Cl. CPC G06T 13/40; G06F 17/16

(57) ABSTRACT

Method for generating frames of facial animation comprises: obtaining a plurality of frames of training data comprising, for each frame: a training representation comprising geometric information for a plurality of primary face vertices and a plurality of secondary facial component vertices. The facial animation training data comprises indices of a subset of the plurality of primary face vertices. The method comprises: training a secondary facial component model using the facial animation training data; obtaining frames of primary face animation, each frame comprising geometric information for a plurality of primary face vertices; and, for each frame of primary face animation, generating a corresponding frame of secondary facial component animation based on the frame of primary face animation and the secondary facial component model, the corresponding frame of the secondary facial component animation comprising geometric information for secondary facial component vertices based on the primary face geometry.

### REFERENCE TO RELATED APPLICATIONS

This application is a continuation of Patent Cooperation Treaty (PCT) application No. PCT/CA2022/051156 having an international filing date of 27 Jul. 2022 which in turn claims priority from, and for the purposes of the United States the benefit under 35 USC 119 in connection with, U.S. application No. 63/227,333 filed 29 Jul. 2021. All of the applications referred to in this paragraph are hereby incorporated herein by reference.

### TECHNICAL FIELD

This application is directed to systems and methods for computer animation of faces. More particularly, this application is directed to systems and methods for animating secondary facial components based on animation of the facial geometry.

### BACKGROUND

Computer animation of faces (e.g. the faces of humans or other characters) can involve animation of the primary facial geometry together with the geometries of a number of secondary facial components (e.g. hair, facial hair, jaw bone, eyebrows (left and right), eyelashes (upper and lower; left and right), tongue and/or the like) which may have some dependence on the primary facial geometry—i.e. the geometry of the skin that covers the face. In current animation techniques, animating these secondary facial components may be done manually by an artist (e.g. on a frame by frame basis) or procedurally, by way of a facial animation rig, which specifies the dependency of the geometries of secondary facial components on the primary facial geometry. These dependencies are expressed in terms of geometrical operations available in the 3D animation rig application, such as anchoring the secondary geometry to a fixed point in the primary geometry (such that any rotation/translation of the primary geometry point will be applied to the secondary geometry). Offline (i.e. non-real-time) 3D animation applications (such as facial animation rigs) tend to provide a rich set of operators, and can have custom ones added that can be combined into a complex network of rules to drive such geometries. These offline 3D animation applications are not suitable for real time applications, where the primary face geometry may change several times per second (e.g. with each frame of animation video). In contrast, there are realtime 3D animation applications (such as, for example, Unreal Engine™ produced by Epic Games and/or the like) which provide a limited range of pre-defined operators that are suited for efficient (i.e. realtime) computation. Currently, there are no direct mappings for the operators between offline 3D animation applications and real time 3D animation applications. There is a general desire to be able to accommodate information relating to the dependence of secondary facial components on primary face geometry from non-real time animation setups (e.g. from artists and/or from facial animation rigs) and to compress this information into secondary facial component animation information that may be deployed to real-time animation applications with their limited toolset.

The secondary facial components of a human face may pose particular challenges to realistic animation, and in particular to realistic animation in real-time. Secondary facial components may be inherently complex to realistically animate due to the number of points (or vertices) used to model each secondary facial component and the dependence of these secondary facial components on the primary facial geometry. Furthermore, the animation of secondary facial components may depend on each other. For example, animation of an upper eyelash depends on the primary facial geometry, but in some circumstances (e.g. when a character is squinting), the upper eyelash can be touched and pushed away by other secondary facial components, such as the character's eyebrow or lower eyelashes.

To realistically animate a face in real time, there is a desire to animate both the primary facial geometry and the geometries of secondary facial components within the perception time of a human observer. For example, for real-time animation at a frame rate of 24 frames per second, a frame of an animation must be generated within 0.0416 seconds. However, this frame generation rate will typically include the entire animation of the frame and, consequently, the temporal budget for animating the face (and in particular for secondary facial components) may be significantly less than this.

There is a general desire for a method of animating secondary facial components which takes into account the primary facial geometry.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a method for generating one or more frames of computer-based facial animation. The method comprises: obtaining, at a processor, a plurality of frames of facial animation training data, the facial animation training data comprising, for each of the plurality of frames of facial animation training data: a training representation of a training primary face geometry comprising geometric information for a training plurality of primary face vertices; and a corresponding training representation of a training secondary facial component geometry comprising geometric information for a training plurality of secondary facial component vertices. The facial animation training data further comprises a subset index comprising indices of a subset of the training plurality of primary face vertices. The method comprises: training, by the processor, a secondary facial component model using the facial animation training data; obtaining, at the processor, one or more frames of primary face animation, each of the one or more frames of primary face animation comprising an animation representation of an animation primary face geometry comprising geometric information for an animation plurality of primary face vertices; and, for each of the one or more frames of primary face animation: generating, by the processor, a corresponding frame of secondary facial component animation based on the frame of primary face animation and the secondary facial component model, the corresponding frame of the secondary facial component animation comprising an animation representation of an animation secondary facial component geometry comprising geometric information for an animation plurality of secondary facial component vertices wherein the secondary facial component geometry is based on the animation primary face geometry.

Another aspect of the invention provides a method for training a secondary facial component model for use in computer-based facial animation wherein the secondary facial component model takes as input one or more frames of primary face animation, each of the one or more frames of primary face animation comprising an animation representation of an animation primary face geometry comprising geometric information for an animation plurality of primary face vertices and outputs, for each of the one or more frames of primary face animation, a corresponding frame of secondary facial component animation comprising an animation representation of an animation secondary facial component geometry comprising geometric information for an animation plurality of secondary facial component vertices wherein the secondary facial component geometry takes into account the primary face geometry. The method comprises obtaining, at a processor, a plurality of frames of facial animation training data, the facial animation training data comprising, for each of the plurality of frames of facial animation training data: a training representation of a training primary face geometry comprising geometric information for a training plurality of n primary face vertices; and a corresponding training representation of a training secondary facial component geometry comprising geometric information for a training plurality of m secondary facial component vertices. The facial animation training data further comprises a subset index comprising indices of a subset p of the training plurality of n primary face vertices (p≤n). The method comprises: training the secondary facial component model using the facial animation training data. Training the secondary facial component model using the facial animation training data comprises: performing a matrix decomposition (e.g. principal component analysis (PCA), independent component analysis (ICA), non-negative matrix factorization (NMF), any other suitable matrix decomposition or dimensionality reduction technique and/or the like) of a combined training matrix, which includes a plurality of f frames, each of the plurality of f frames comprising p primary face training vertex locations corresponding to the subset p of the plurality of n primary face vertices; and m secondary facial component training vertex locations, to yield a combined matrix decomposition; and generating the secondary facial component model based on the combined matrix decomposition.

The animation representation of the animation primary face geometry may comprise, for each of the one or more frames of primary face animation, a plurality of k primary face animation blendshape weights. The animation representation of the animation secondary facial component geometry may comprise, for each corresponding frame of secondary facial component animation, a plurality of q secondary facial component animation blendshape weights.

The secondary facial component model may comprise a weight-conversion matrix C and, for each of the one or more frames of primary face animation, generating the corresponding frame of secondary facial component animation based on the frame of primary face animation and the secondary facial component model may comprise right multiplying the weight conversion matrix C by the plurality of k primary face animation blendshape weights for the frame of primary face animation to yield, within an offset vector, the plurality of q secondary facial component animation blendshape weights for the corresponding frame of secondary facial component animation.

The secondary facial component model may comprise a weight-conversion offset vector \vec{γ} and, for each of the one or more frames of primary face animation, generating the corresponding frame of secondary facial component animation based on the frame of primary face animation and the secondary facial component model may comprise adding the weight-conversion offset vector \vec{γ} to a product of the right multiplication of the weight conversion matrix C by the plurality of k primary face animation blendshape weights for the frame of primary face animation to yield the plurality of q secondary facial component blendshape weights for the corresponding frame of secondary facial component animation.

The method may comprise performing the steps of obtaining, at the processor, one or more frames of primary face animation and, for each of the one or more frames of primary face animation, generating, by the processor, a corresponding frame of secondary facial component animation based on the frame of primary face animation and the secondary facial component model: in real time. Real time may comprise a at a rate at least as fast as an animation frame rate for each of the one or more frames, at a rate of at least frames per second, and/or at a rate of at least 24 frames per second.

Obtaining the plurality of frames of facial animation training data may comprise receiving the training representation of the training primary face geometry and the training representation of the training second facial component geometry from a computer-implemented animation rig. Obtaining the plurality of frames of facial animation training data may comprise receiving the training representation of the training primary face geometry and the training representation of the training second facial component geometry at least in part from user input.

The subset index may comprise indices of a subset of p primary face vertices where a number p of the subset is less than or equal to a number of the plurality of primary face vertices. The subset index may comprise indices of a subset of p primary face vertices that are selected by a user as being relevant to the secondary facial component geometry. The subset index may comprise indices of a subset of p primary face vertices that are proximate (e.g. within a proximity threshold or selected as the most proximate p primary face vertices) to the secondary facial component geometry. The subset index may comprise indices of a subset of p primary face vertices determined to be relevant to the secondary facial component geometry. This relevance may be determined based on a set of p primary face vertices that are relevant to how the secondary facial component geometry moves in relation of the primary face geometry.

Obtaining the plurality of frames of facial animation training data may comprise at least one of obtaining or converting the training representation of the training primary face geometry to, for each of the one or more frames of facial animation training data, a plurality of n primary face training vertex locations, each primary face training vertex location comprising 3 coordinates.

Obtaining the plurality of frames of facial animation training data may comprise at least one of obtaining or converting the training representation of the training primary face geometry to, for each of the one or more frames of facial animation training data, locations for each of the subset of p primary face vertices, each of the p primary face vertices comprising 3 coordinates.

Obtaining the plurality of frames of facial animation training data may comprise at least one of obtaining or converting the training representation of the training secondary facial component geometry to, for each of the one or more frames of facial animation training data, a plurality of m secondary facial component training vertex locations, each secondary facial component training vertex location comprising 3 coordinates.

Training the secondary facial component model using the facial animation training data may comprise: performing a matrix decomposition (e.g. principal component analysis (PCA), independent component analysis (ICA), non-negative matrix factorization (NMF), any other suitable matrix decomposition or dimensionality reduction technique and/or the like) of a combined training matrix, which includes a plurality of f frames, each of the plurality of f frames comprising p primary face training vertex locations corresponding to the subset of p primary face vertices; and m secondary facial component training vertex locations, to yield a combined matrix decomposition; and generating the secondary facial component model based on the combined matrix decomposition.

The combined matrix decomposition may comprise: a combined basis matrix having dimensionality [q, 3(m+p)] where q is a number of blendshapes for the combined matrix decomposition; and a combined mean vector having dimensionality 3(m+p).

Generating the secondary facial component model based on the combined matrix decomposition may comprise generating, from the combined matrix decomposition: a combined primary subset basis matrix having dimensionality [q, 3p] by extracting 3p vectors of length q (e.g. 3p columns) from the combined basis matrix which correspond to the subset of p primary face vertices; and a combined primary subset mean vector having dimensionality 3p by extracting 3p elements from the combined mean vector which correspond to the subset of p primary face vertices.

Generating the secondary facial component model based on the combined matrix decomposition may comprise generating, from the combined matrix decomposition: a secondary facial component basis matrix having dimensionality [q, 3m] by extracting 3m vectors of length q (e.g. 3m columns) from the combined basis matrix which correspond to the m secondary facial component vertices; and a secondary facial component mean vector having dimensionality 3m by extracting 3m elements from the combined mean vector which correspond to the m secondary facial component vertices.

Generating the secondary facial component model based on the combined matrix decomposition may comprise: generating a projection matrix P having dimensionality [q, 3p] based on the combined primary subset basis matrix, wherein the projection matrix P will project a vector of 3p positions or offsets of the subset of p primary face vertices into a corresponding set of weights for the combined primary subset basis matrix; and generating a weight-conversion matrix C that forms part of the secondary facial component model based at least in part on the projection matrix P.

Generating the projection matrix P may comprise selecting the projection matrix P that will minimize an error associated with converting the weights from the combined primary subset basis matrix back to the 3p positions or offsets of (e.g. reconstructing) the subset of p primary face vertices. Generating the projection matrix P may comprise selecting the projection matrix P that will minimize a least squares error associated with converting the weights for the combined primary subset basis matrix back to the 3p positions or offsets of (e.g. reconstructing) the subset of p primary face vertices using the combined primary subset basis matrix. Generating the projection matrix P may comprise calculating the projection matrix P according to P=(A^{T}A)⁻¹A^{T} where A^{T} is the combined primary subset basis matrix and A is its transposed form.

Generating the weight-conversion matrix C that forms part of the secondary facial component model based at least in part on the projection matrix P may comprise: determining a matrix of primary vertex subset blendshapes V* having dimensionality [k, 3p] based on the primary face animation; and generating the weight-conversion matrix C according to C=PV*^{T}.

The animation representation of the animation primary face geometry may comprise a primary face blendshape matrix of dimensionality [k, 3n], where k represents a number of primary face blendshapes in a blendshape decomposition of the animation primary face geometry and n represents a number of vertices of the animation primary face geometry; and determining the matrix of primary vertex subset blendshapes V* based on the primary face animation may comprise extracting, from the primary face blendshape matrix, the 3p vectors of length k (e.g. 3p columns) which correspond to the subset of p primary face vertices.

The animation representation of the animation primary face geometry may comprise, for each of the one or more frames of primary face animation, a plurality of k primary face animation blendshape weights. The animation representation of the animation secondary facial component geometry may comprise, for each of the one or more frames of primary face animation, a plurality of q secondary facial component animation blendshape weights. For each of the one or more frames of primary face animation, generating the corresponding frame of secondary facial component animation based on the frame of primary face animation and the secondary facial component model may comprise right multiplying the weight-conversion matrix C by the plurality of k primary face animation blendshape weights for the frame of primary face animation to yield, within an offset vector, a vector comprising the plurality of q secondary facial component animation blendshape weights for the corresponding frame of secondary facial component animation.

Generating the secondary facial component model based on the combined decomposition may comprise generating a weight-conversion offset vector \vec{γ} that forms part of the secondary facial component model based at least in part on the projection matrix P.

Generating the weight-conversion offset vector \vec{γ} that forms part of the secondary facial component model based at least in part on the projection matrix P may comprise: determining an input primary vertex subset mean vector \vec{μ}* of dimension 3p based on the primary face animation; and generating the weight-conversion offset vector \vec{γ} according to \vec{γ}=P(\vec{μ}*−\vec{ω}*), where \vec{ω}* is the combined primary subset mean vector of dimension 3p.

The animation representation of the animation primary face geometry may comprise an input primary face mean vector of dimension 3n where n represents a number of vertices of the primary face geometry; and determining the input primary vertex subset mean vector \vec{μ} based on the primary face animation comprises extracting, from the input primary face mean vector, the 3p elements which correspond to the subset of p primary face vertices.

The animation representation of the animation primary face geometry may comprise, for each of the one or more frames of primary face animation, a plurality of k primary face animation blendshape weights. The animation representation of the animation secondary facial component geometry may comprise, for each of the one or more frames of primary face animation, a plurality of q secondary facial component animation blendshape weights.

For each of the one or more frames of primary face animation, generating the corresponding frame of secondary facial component animation based on the frame of primary face animation and the secondary facial component model may comprise: right multiplying the weight-conversion matrix C by the plurality of k primary face animation blendshape weights for the frame of primary face animation to yield, within an offset vector, the plurality of q secondary facial component animation blendshape weights for the corresponding frame of secondary facial component animation; and adding the weight-conversion offset vector \vec{γ} to a product of the right multiplication of the weight conversion matrix C by the plurality of k primary face animation blendshape weights for the frame of primary face animation to yield a vector comprising the plurality of q secondary facial component blendshape weights for the corresponding frame of secondary facial component animation.

For each of the one or more frames of primary face animation, generating, by the processor, the corresponding frame of secondary facial component animation based on the frame of primary face animation and the secondary facial component model may comprise: reconstructing a three-dimensional vertex geometry (independent or offset from neutral) for the corresponding frame of secondary facial component animation according to \vec{a}=\vec{t}D+\vec{α} where \vec{t} is the vector comprising the plurality of q secondary facial component blendshape weights for the corresponding frame of secondary facial component animation, D is the secondary facial component basis matrix having dimensionality [q, 3m], \vec{α} is the secondary facial component mean vector having dimensionality 3m and \vec{a} is a vector comprising the 3m coordinates for the m secondary facial component vertices.

It is emphasized that the invention relates to all combinations of the above features, even if these are recited in different claims.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A depicts an exemplary system for performing one or more methods described herein according to a particular embodiment.

FIGS. 1B and 10 depict an exemplary method for animating a secondary facial component with a secondary facial component animation model according to one embodiment of the present invention.

FIG. 2 depicts an exemplary method for generating training data for training a secondary facial component animation model according to one embodiment of the present invention.

FIGS. 3A to 3C depict an exemplary method for training a secondary facial component animation model according to one embodiment of the present invention.

FIGS. 4A to 4D depict various representations of renderings made using the system of FIG. 1A and the animation method of FIGS. 1B and 10 comprising primary facial geometries and the corresponding geometries of secondary facial components (in this case the upper and lower, right and left eyelashes and right and left eyebrows).

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

One aspect of the invention provides a method for animating a secondary facial component using a primary facial representation (primary facial geometry) and a secondary facial component animation model. The method generates a secondary component representation for a given primary facial representation on a frame by frame basis. The method may generate a secondary component representation for a given primary facial representation on a frame by frame basis in real time—e.g. many times per second in accordance with a given animation frame rate.

The animation method may take, as input, a primary facial representation and a secondary facial component animation model trained for the particular secondary facial component. The method may generate a secondary facial component representation (secondary facial component geometry) corresponding to the primary facial representation (primary facial geometry). Where the primary facial representation is a representation of the primary facial geometry for a frame of an animation, the secondary facial component representation generated by the method corresponds to a representation of the secondary facial component (secondary facial component geometry) for the same animation frame.

The input primary facial representation may comprise a set of primary blendshape weights (e.g. primary component analysis (PCA) blendshape weights or the blendshape weights of some other form of matrix decomposition technique or dimensionality reduction technique (e.g. independent component analysis (ICA), non-negative matrix factorization (NMF) and/or the like)) for each frame. These primary blendshape weights may be converted and/or convertible to a primary facial vertex geometry on a frame-by-frame basis by computing a weighted sum of primary blendshapes. Each primary blendshape may be defined using inherent geometry or may be defined using offsets from some neutral (or mean) primary blendshape. Similarly, the output secondary facial component representation may comprise a set of secondary component blendshape weights (e.g. PCA blendshape weights or the blendshape weights of some other form of matrix decomposition technique or dimensionality reduction technique (e.g. independent component analysis (ICA), non-negative matrix factorization (NMF) and/or the like)) for each frame. These secondary component blendshape weights may be converted and/or convertible to a secondary component facial vertex geometry on a frame-by-frame basis by computing a weighted sum of secondary component blendshapes. Each secondary component blendshape may be defined using inherent geometry or may be defined using offsets from some neutral (or mean) secondary component blendshape.

The animation method may be repeated for multiple secondary facial components, and each secondary facial component representation may be combined with the primary facial representation to generate a complete representation (complete geometry) of the face. The complete representation of the face may represent the face in an animation frame. The animation method may be further repeated (e.g. in real-time) for a series of animation frames of the face, thereby generating an animation of the face.

In some embodiments of the animation method, the primary facial representation and the secondary facial component representation each comprise a set of blendshape weights (e.g. principal component analysis (PCA) blendshape weights or the blendshape weights of some other form of matrix decomposition technique or dimensionality reduction technique (e.g. independent component analysis (ICA), non-negative matrix factorization (NMF) and/or the like)). A facial component geometry (e.g. primary facial geometry and/or the geometry of a secondary facial component) may be described by one or more (typically a plurality of) blendshapes. Each blendshape may be defined using inherent geometry or may be defined using offsets from some neutral (or mean) blendshape. Each blendshape may be weighted with a corresponding blendshape weight, and the weighted blendshapes may be combined (e.g. summed) into a complete representation of the component geometry. That is, the geometry of a facial component may be defined by a weighted sum of the blendshapes for that facial component.

One aspect of the invention provides a method for training a secondary facial component animation model. The method may take, as input, a primary facial animation, a corresponding secondary facial component animation and a subset of the primary face vertices (primary facial geometry vertex subset) which correspond to (e.g. which are proximate to) the vertices of the secondary facial component for which the model is being trained and may generate the secondary facial component animation model. The primary facial animation and secondary facial component animation may each comprise a series of sets of blendshape weights—e.g. one set of primary facial blendshape weights for each animation frame and one set of secondary component blendshape weights for each animation frame. The primary facial geometry vertex subset may comprise information (e.g. indices) that identify a set of vertices within the primary face representation that correspond to (e.g. which are proximate to) the vertices of the secondary facial component for which the model is being trained. As explained in more detail below, the secondary facial component animation model generated by the method may comprise: a weight-conversion matrix (which converts primary facial weights into secondary component weights); and weight-conversion offset vector.

The weight-conversion matrix and weight-conversion offset vector generated by the training method (i.e. the facial component animation model) may be used in an inference method to generate secondary component blendshape weights from primary facial blendshape weights. The secondary component blendshape weights may be used to generate a secondary facial component geometry for a given primary face geometry.

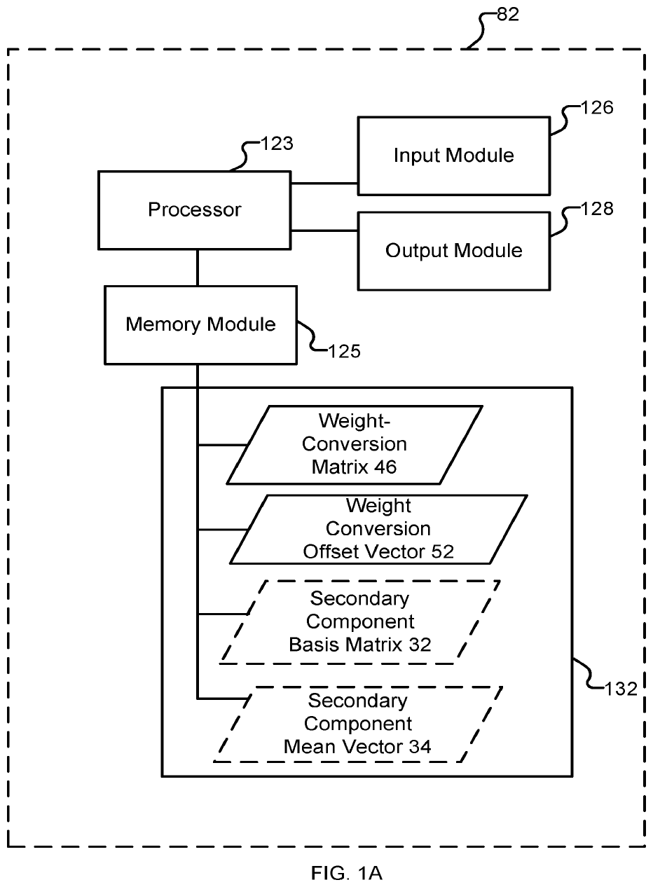

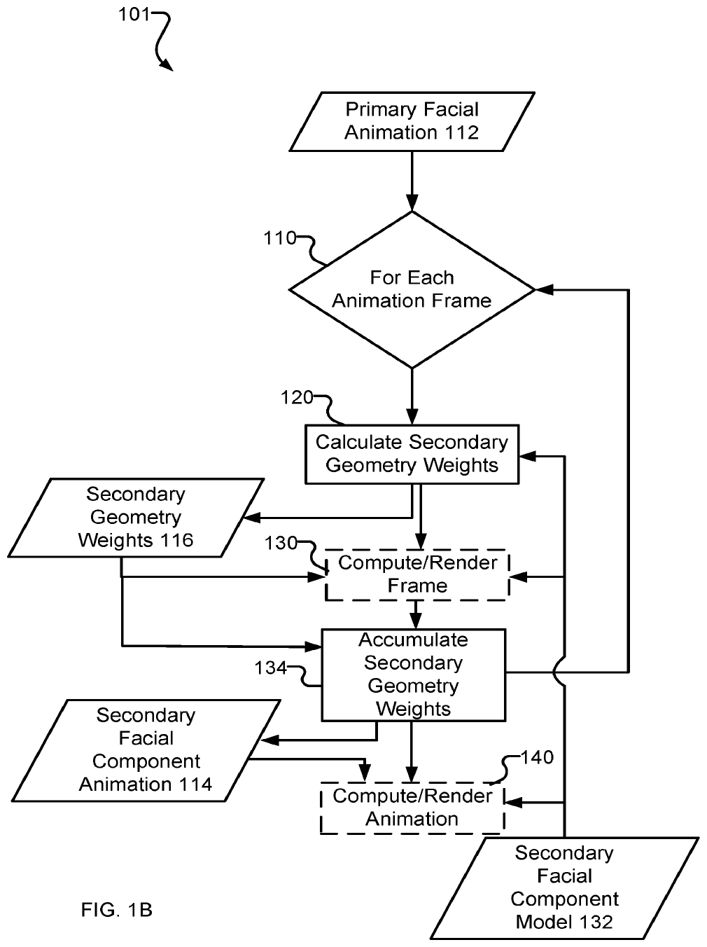

Some aspects of the invention provide a system 82 (an example embodiment of which is shown in FIG. 1A) for performing one or more of the methods described herein.

System 82 may comprise a processor 123, a memory module 125, an input module 126, and an output module 128. Memory module 125 may store one or more of the models and/or representations described herein. Processor 123 may train one or more secondary facial component animation models 132 described herein, and store the secondary facial component animation models 132 in memory module 125. In the FIG. 1A embodiment, secondary facial component animation model 132 comprises a weight-conversion matrix 46, a weight-conversion offset vector 52, optionally a secondary component basis matrix 32 and optionally a secondary component mean vector 34 which are explained in more detail below. Processor 123 may retrieve a secondary facial component animation model 132 from memory module 125 and generate a secondary facial component animation from a primary facial animation.

FIGS. 1B and 10 depict an exemplary, non-limiting method 101 for animating a secondary facial component (generating secondary facial component animation 114) using, as inputs, a primary facial animation 112 and a secondary facial component animation model 132 according to a particular embodiment. Method 101 may be understood to be a method for inferring secondary facial component animation 114 based on primary facial animation 112.

Method 101 takes as input a primary facial animation (primary facial geometry (e.g. on a frame-by-frame basis)) 112 and secondary facial component animation model 132 and generates secondary facial component animation (secondary facial component geometry (e.g. on a frame-by-frame basis)) 114. Method 101 may optionally generate and/or render images (animation frames) including the secondary facial component for a particular frame (step 130) or for some or all of the frames in secondary facial component animation 114 (step 140). These generation and/or rendering steps are described in more detail below.

Each frame of primary facial animation 112 and each frame of secondary facial component animation 114 may take a number of representational forms. In some embodiments, each frame of primary facial animation 112 may be represented by a number n of vertices, with three geometric coordinates (e.g. {x, y, z}) for each vertex. In such embodiments, each frame of primary facial animation 112 may be represented by a vector of dimension 3n. As is known in the art, the 3n coordinates or each frame of primary facial animation 112 may be independent coordinates in some coordinate system or may be represented as offsets from some mean or neutral frame (also referred to as a mean or neutral vector). For example, where a neutral frame of primary facial animation 112 has coordinates [x_{1,0}, y_{1,0}, z_{1,0} . . . x_{n,0}, y_{n,0}, z_{n,0}] and a particular i^{th} frame of primary facial animation 112 has coordinates [x_{1,i}, y_{1,i}, z_{1,i} . . . x_{n,i}, y_{n,i}, z_{n,i}], then the iₜₕ frame could also be represented as offsets from the neutral frame as has coordinates [(x_{1,i}-x_{1,0}), (y_{1,i}-y_{1,0}), (z_{1,i}-z_{1,0}), . . . (x_{n,i}-x_{n,0}), (y_{n,i}-y_{n,0}), (z_{n,i}-z_{n,0})].

Each frame of primary animation 112 and each frame of secondary facial component animation 114 may be decomposed into so-called blendshapes, where each blendshape has the above-discussed vector representation—i.e. a set of vertices with three geometric coordinates (e.g. {x, y, z}) for each vertex, where such coordinates could be independent coordinates or offsets from a mean vector. For example, where primary facial animation 112 is decomposed into a set of k blendshapes and the primary face geometry is defined by n vertices, then each one of the k blendshapes of primary facial animation 112 may be a vector of dimension 3n. Similarly, where secondary facial component animation 114 is decomposed into a set of q blendshapes and the secondary component geometry is defined by m vertices, then each one of the q blendshapes of secondary facial component animation 114 may be a vector of dimension 3m. In a blendshape representation, each frame of primary facial animation 112 and/or each frame of secondary facial component animation 114 may comprise a set of blendshape weights which may be used to recreate the vertices of that frame using a weighted combination of blendshapes. For example, where primary facial animation 112 is decomposed into a set of k blendshapes, then each frame of primary facial animation 112 may be represented by a primary facial component weight vector of dimension k and the vertices (independent or offset) and corresponding geometry of that frame may be recreated by the weighted combination of the k blendshapes. For example, the vertices of the i^{th} frame of primary facial animation 112 can be recreated according to [(x_{1,i}-x_{1,0}), (y_{1,i}-y_{1,0}), (z_{1,i}-z_{1,0}), . . . (x_{n,i}-x_{n,0}), (y_{n,i}-y_{n,0}), (z_{n,i}-z_{n,0})]=w_{1,i}\vec{b}₁+w_{2,i}\vec{b}₂+ . . . w_{k,i}\vec{b}ₖ where {w_{1,i}, w_{2,i}, . . . w_{k,i}} are the k weights corresponding to the i^{th} frame and {\vec{b}₁, \vec{b}₂, . . . \vec{b}ₖ} are the k blendshapes corresponding to primary facial animation 112 with the offset representation where each of the k blendshape vectors has dimensionality 3n.

This expression may be represented in matrix form for an animation comprising f frames by X=ZV where V is a basis matrix of dimensionality [k,3n] where each row is one of the k blendshapes {\vec{b}₁, \vec{b}₂, . . . \vec{b}ₖ}, Z is a weight matrix of dimensionality [f, k] where each row comprises the k blendshape weights for a particular one of the f frames and X is a matrix of dimensionality [f, 3n] where each row of represents the geometry (3n coordinates) of one of the f frames of the primary facial animation 112 with the offset representation. Accordingly, primary animation 112 used as input for method 101 may be encoded as a series of sets of blendshape weights (one set of weights (e.g. a set of k weights for k corresponding blendshapes) per frame).

Similarly, where secondary facial component animation 114 is decomposed into a set of q blendshapes, then each frame of secondary facial component animation 114 may be represented by a secondary facial component weight vector of dimension q and the vertices (independent or offset) and corresponding geometry of that frame may be recreated by the weighted combination of the q blendshapes. Accordingly, secondary facial component animation 114 output from method 101 may be encoded as a series of sets of blendshape weights (one set of weights (e.g. a set of q weights for q corresponding blendshapes) per frame).

In accordance with method 101 shown in FIGS. 1B and 10, the animation 114 of the secondary facial component over the series of animation frames corresponds to the animation 112 of the primary facial geometry over the same series of animation frames.

That is, inference method 101 may infer one frame of secondary facial component animation 114 for each frame of primary facial animation 112.

Step 110 of method 101 comprises performing step 120, optional step 130 and step 134 for each frame of primary facial animation 112. Step 120 generates a set of secondary component blendshape weights 116 for each frame of primary facial animation 112 and step 134 accumulates these sets of secondary component blendshape weights for each frame of primary facial animation 112 to provide secondary facial component animation 114. In the illustrated embodiment, secondary facial component animation 114 comprises a series of sets of secondary component blendshape weights 116, where each set of secondary component blendshape weights 116 (generated by step 120 and accumulated by step 134) corresponds to a frame of primary facial animation 112 and/or, equivalently, to the blendshape weights for the frame of primary facial animation 112.

FIG. 10 depicts a method 121 which may be used to implement step 120 of method 101 (FIG. 1B) according to a particular embodiment. As discussed above, step 120 (and method 121) are performed for each frame of primary feature facial animation 112. In the FIG. 10 embodiment, method 121 (step 120) receives as input a set of primary blendshape weights 112′ corresponding to a particular frame of primary facial animation 112 and weight-conversion matrix 46 and weight-conversion offset vector 52 from facial component animation model 132. For example, facial animation blendshape weights 112′ may comprise a vector of dimension k, where k is the number of blendshapes used to represent primary facial animation 112. In the FIG. 10 embodiment, method 121 (step 120) comprises steps 122 and 124.

Step 122 of method 101 comprises multiplying primary blendshape weights 112′ with weight-conversion matrix 46 of secondary facial component animation model 132 to generate product 136. Weight-conversion matrix 46 may comprise a matrix of dimension [q, k], such that the product 136 of weight-conversion matrix 46 and facial animation blendshape weights 112′ yields a product vector 136 of dimensionality q.

Step 124 of method 101 comprises adding weight-conversion offset vector 52 of secondary facial component animation model 132 to product 136 to generate secondary component blendshape weights 116 for the frame under consideration. Weight-conversion offset vector 52 may have dimensionality q (i.e. the same dimensionality as product 136), such that secondary component blendshape weights 116 also have dimensionality q.

Referring back to FIG. 1B, repeating step 120 multiple times (once per each frame) yields a set of secondary component blendshape weights 116 for each frame which, when accumulated frame-by-frame in step 134, provide secondary facial component animation 114. Each set of secondary component blendshape weights 116 (one set per frame of secondary facial component animation 114) may be a vector of dimensionality q. As discussed above, for the purposes of generating and/or rendering image frames (e.g. in optional steps 130, 140), the vertex geometry (independent or offset) of each frame of secondary facial component animation 114 can be recreated by multiplying the corresponding blendshape weight vector 116 by a matrix of q secondary component blendshapes. Image generation and/or rendering steps 130, 140 and this vertex geometry reconstruction are explained in more detail below.

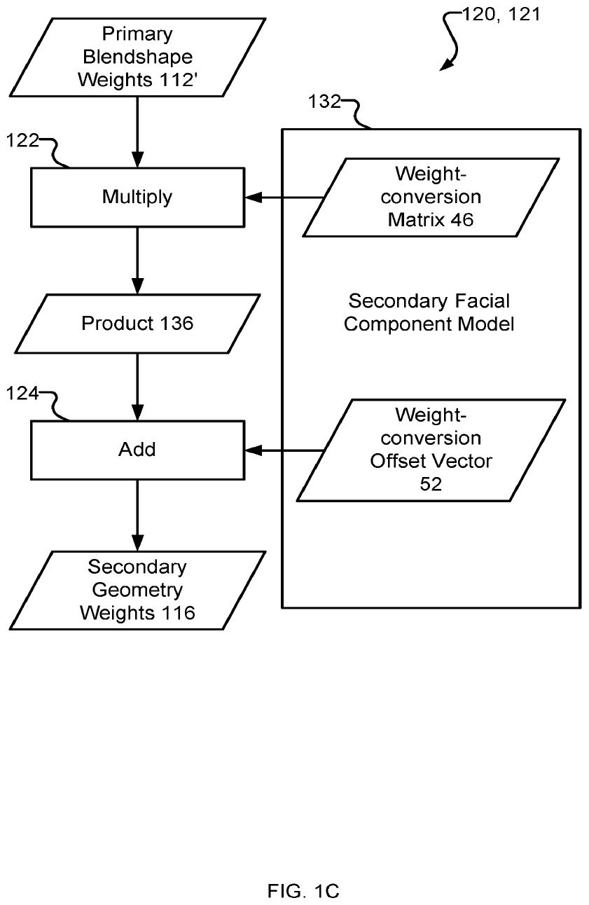

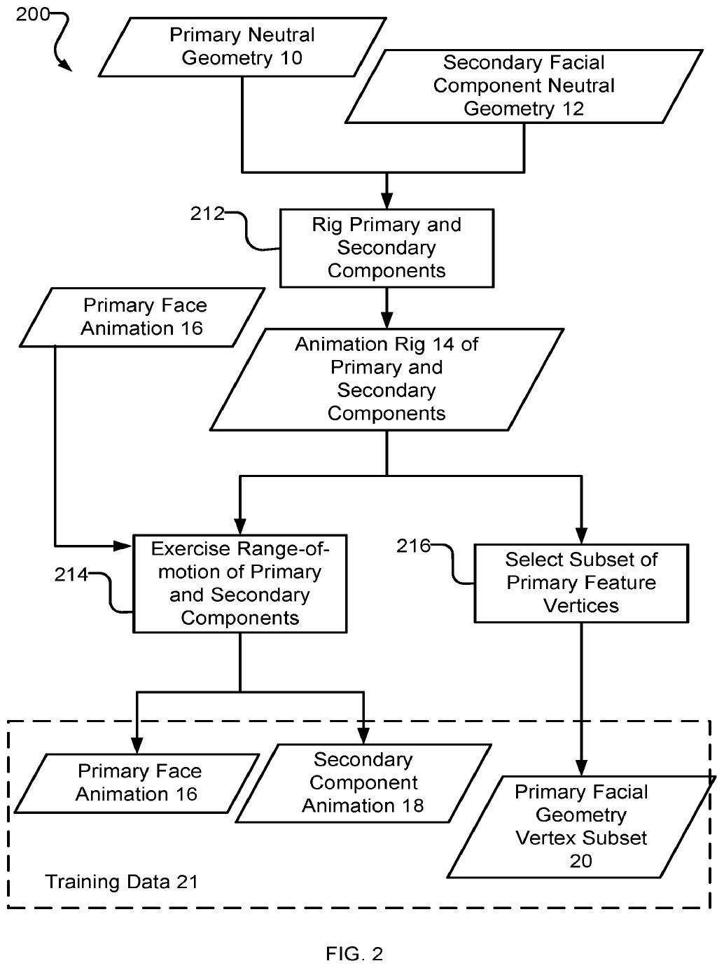

FIG. 2 depicts an exemplary, non-limiting method 200 for generating training data 21 for training a secondary facial component animation model (e.g. secondary facial component animation model 132 shown in FIG. 10). The FIG. 2 method 200 may be performed for each secondary facial component that is sought to be modelled—e.g. once for each of eyelash, each eyebrow, jaw bone, facial hair, tongue and/or the like.

Method 200 takes as input: a primary face neutral representation (primary face neutral geometry) 10, a secondary facial component neutral representation (secondary component neutral geometry) 12 and a primary face animation 16. In some embodiments, method 200 may take, as input, other shapes (e.g. blendshapes and/or vertex-based geometries) of primary face geometry. Method 200 generates training data 21 which can subsequently be used for training a secondary facial component animation model 132 for animating a secondary facial component.

Primary face neutral representation 10 may correspond to one particular facial surface geometry and primary face animation 16 may correspond to a range-of-motion sequence of frames of the facial surface geometry. Primary face neutral representation 10 and each frame of primary face animation 16 may have the same topology (i.e. be represented by, or convertible to, the same data structure). Primary face neutral representation 10 may comprise the geometry of one of the frames of primary face animation 16, although this is not necessary. In some embodiments, primary face neutral representation 10 may be selected as a frame of primary face animation 16 or otherwise obtained from primary face animation 16, so that primary face neutral representation 10 is not strictly required as an input to method 200. Primary face animation 16 may be acquired using facial motion capture techniques, generated by one or more artists, generated using a facial rig, transferred from another character and/or the like. Primary face neutral representation 10 and each frame of primary face animation 16 may be represented by a set of n vertices, each having {x, y, z} coordinates which in turn may be represented as a vector of length 3n. Additionally or alternatively, primary face neutral representation 10 and each frame of primary face animation 16 may be represented by a set of primary blendshape weights (e.g. k blendshape weights), where each primary blendshape comprises a known vector of length 3n representing the locations of a set of n vertices, each having {x, y, z} coordinates and the weighted sum of the primary blendshapes yields the geometry of the primary face neutral representation 10 or the frame of the primary face animation 16, as the case may be. It will be appreciated that primary face neutral representation 10 and each frame of primary face animation 16 may comprise either or both of, or be convertible back and forth between, representations as a vector of length 3n representing vertex locations and a set of primary blendshape weights corresponding to a suitable set of primary blendshape vectors (blendshapes) each having length 3n.

Secondary component neutral representation 12 may correspond to a geometry (e.g. a surface geometry) of a secondary facial component, for example: facial hair, an eyebrow, an eyelashes, a jaw bone, a tongue and/or the like. Secondary component neutral representation 12 may correspond to the geometry of the secondary facial component when the primary face geometry is primary face neutral representation 10, although this is not necessary. Secondary component neutral representation 12 may be represented by a set of m vertices, each having {x, y, z} coordinates and may be represented as a vector of length 3m.

In the illustrated embodiment, training data 21 comprises primary face animation 16 (i.e. the same primary face animation 16 that is input to method 200), secondary component animation 18 (one frame of secondary component animation 18 for each frame of primary face animation 16) and primary facial geometry vertex subset 20. These elements of training data 21 are explained in more detail below.

Method 200 may be repeated for each of a plurality of secondary components to generate training data 21 for training each of a corresponding plurality of secondary facial component animation models 132.

Step 212 of method 200 comprises generating animation rig 14 by rigging the secondary facial component to the primary facial geometry. Animation rig 14 defines relationships between secondary vertices of the secondary facial component and one or more primary vertices of primary facial geometry. The generation of animation rig 14 is a known process in the field of facial animation and may be performed using commercially available tools, such as Maya™ provided by Autodesk™ and/or other similar software. Animation rig 14 may describe how one or more secondary vertices of the secondary component move in relation to one or more primary vertices of the primary facial geometry. By way of non-limiting example, animation rig 14 may define a transformation of one or more secondary vertices of secondary component neutral representation 12 as a function of the locations of the primary vertices of the primary face geometry, so that when the vertices of the primary face geometry move, animation rig 14 can prescribe a corresponding movement of the secondary vertices. It will be appreciated that animation rig 14 (once generated in step 212) may be able to prescribe the geometry of set of secondary component vertices given a set of primary facial vertices as inputs, animation rig 14 and its corresponding operations are insufficiently fast for use in real time, not available in real time engines (e.g. Unreal Engine™ produced by Epic Games and/or the like) and not easily translated into simple equations. As is explained in more detail below, secondary facial component animation model 132 (once trained) incorporates knowledge from animation rig 14 into a model 132 that may be used to predict, with minimal computation, the geometry of set of secondary component vertices (or blendshape weights) given a set of primary facial vertices (or blendshape weights) as inputs.

Animation rig 14 may be represented by geometrical operations available in a commercial three-dimensional tool (e.g. Maya™ provided by Autodesk™ and/or other similar software) and possibly extended by custom operators. Examples of operations are: collision detection and resolution, smoothing, attraction/repulsion forces, procedurally blending modelled shapes, etc.

Step 214 of method 200 comprises exercising animation rig 14 through a range of motion of the primary face geometry (e.g. primary face animation 16) to generate corresponding frames of primary face animation 16 and secondary facial component animation 18. One or both of primary face animation 16 and secondary component animation 18 may be represented by a tensor. Primary face animation 16 may be represented by a matrix of dimensionality [f, 3n], wherein f is a number of frames of the animation, and n is the number of vertices used to define the primary face geometry. Additionally or alternatively, each frame of face animation 16 may be represented by a set of primary blendshape weights (e.g. k blendshape weights) and together the frames of face animation 16 may be represented by a matrix of dimensionality [f, k] where each row corresponds to a frame of blendshape weights. Secondary component animation 18 may be represented by a matrix of dimensionality [f, 3m], wherein f is the number of frames of the animation, and m is the number of vertices used to define the secondary component.

Step 214 may comprise one or more of:
a user simulating a range of motion of the primary face geometry. Typically an animation rig has user intuitive controls, following standards such as Facial Action Coding System (FACS). Users (animators) with familiarity with such controls can create realistic facial animation by setting the control values on a sparse set of frames, such that their interpolated values will drive the rig and generate the geometries for primary face animation 16 and corresponding secondary component animation 18; and
importing primary face animation 16 captured by motion capture of an actor. Marker-based facial motion capture produces a sparse set of three dimensional points animated over time, corresponding to tracked locations of the actor's face. These points can be used as constraints, in a non-linear solver, to find the corresponding animation rig controls that match the actor's expression. The animation rig 14 will produce the positions matching the tracked markers as well as the geometries for primary face animation 16 and corresponding secondary component animation 18.

Step 216 of method 200 comprises generating primary facial geometry vertex subset 20. Step 216 may be performed by a rigger (i.e. the person who builds animation rig 14). As discussed above, the primary face geometry (e.g. primary face neutral representation 10 and each frame of primary face animation 16) may be represented by a set of n vertices, each having {x, y, z} coordinates. Primary facial geometry vertex subset 20 generated in step 216 corresponds to a subset of the set of n vertices that make-up primary face geometry. In some embodiments, primary facial geometry vertex subset 20 may be represented by a set of p≤n indices corresponding to the p vertices selected from among the n vertices that make-up primary face geometry.

Step 216 and primary facial geometry vertex subset 20 are specific to each secondary component for which method 200 is performed. Step 216 may involve selecting, for each secondary facial component, a subset p of the primary face geometry vertices that are proximate to, or that may be otherwise considered likely to, impact the geometry of the secondary facial component under consideration. For example, where the secondary facial component for which method 200 is being performed is a tongue, step 216 may involve selecting a subset of p vertices corresponding to vertices of primary face geometry that are proximate to the mouth (where the tongue is located). Similarly, where the secondary facial component for which method 200 is being performed is a left lower eyelash, step 216 may involve selecting a subset of p vertices corresponding to vertices of primary face geometry that are proximate to the left eye. While step 216 selection of primary facial geometry vertex subset 20 may be performed by a human rigger to provide maximum artistic flexibility, it will be appreciated that step 216 could be automated using suitable proximity criteria. For example, primary facial geometry vertex subset 20 may be selected to include primary face geometry vertices that are within a suitable threshold proximity of secondary component or to an identifiable region of the primary face geometry.

The output of method 200 is training data 21, which, in the illustrated embodiment, comprises: primary face animation 16, secondary component animation 18 and primary facial geometry vertex subset. As discussed above, primary face animation 16 may be represented by a matrix of dimension [f, 3n], wherein f is a number of frames of the animation, and n is the number of vertices that make-up the primary face geometry; secondary component animation 18 may be represented by a matrix of dimension [f, 3m], wherein f is the number of frames of the animation, and m is the number of vertices that make-up the secondary component geometry; and primary facial geometry vertex subset 20 which may be represented by a set of p≤n indices of a subset of p vertices selected from among the n vertices that make-up the primary face geometry. It will be appreciated that there is a one-to-one correspondence between the frames of primary face animation 16 and secondary component animation 18.

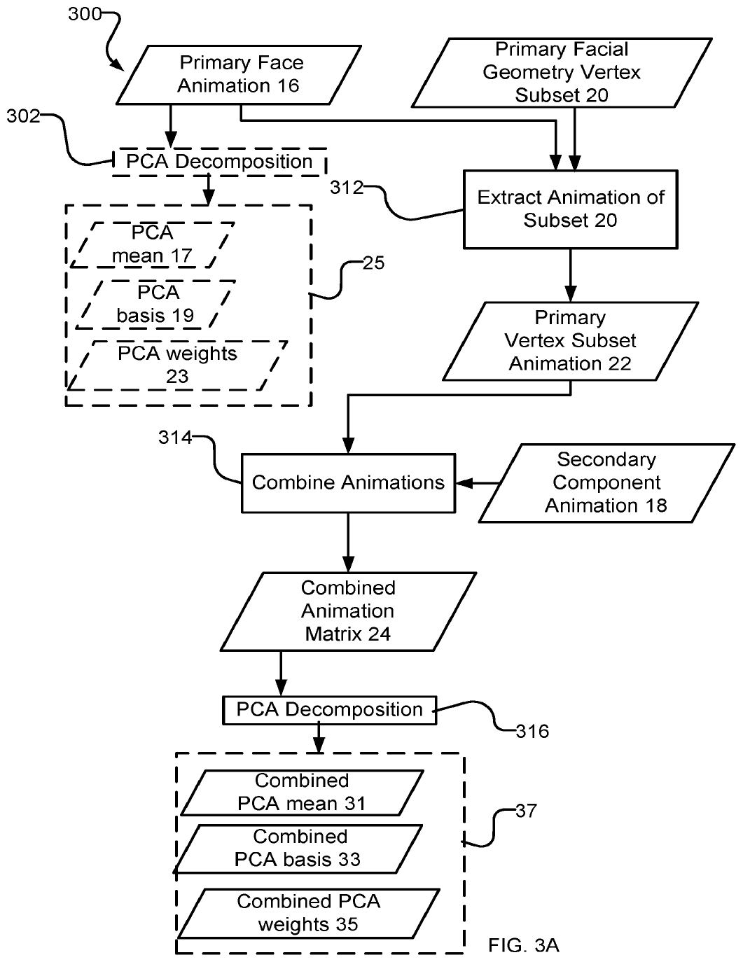

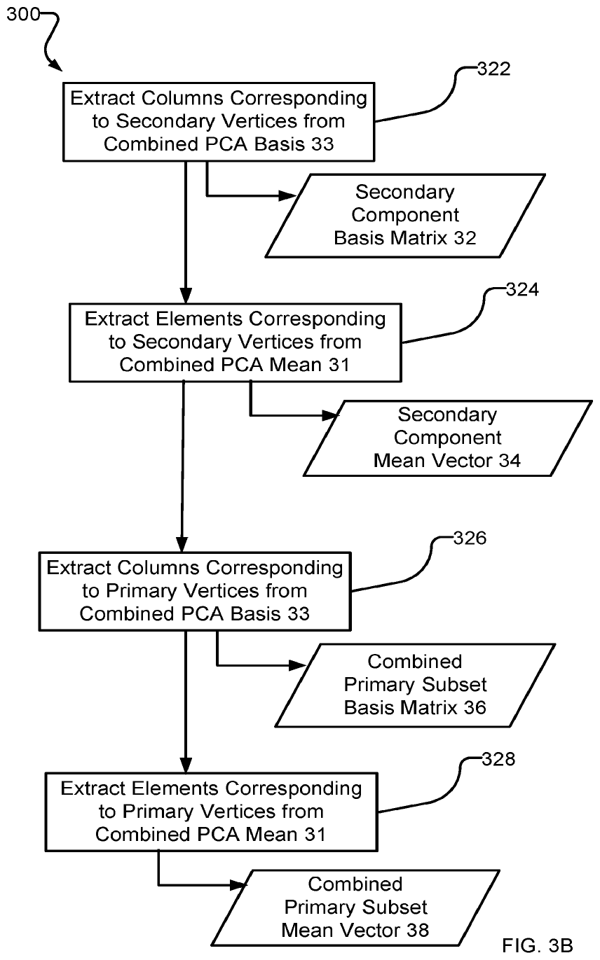

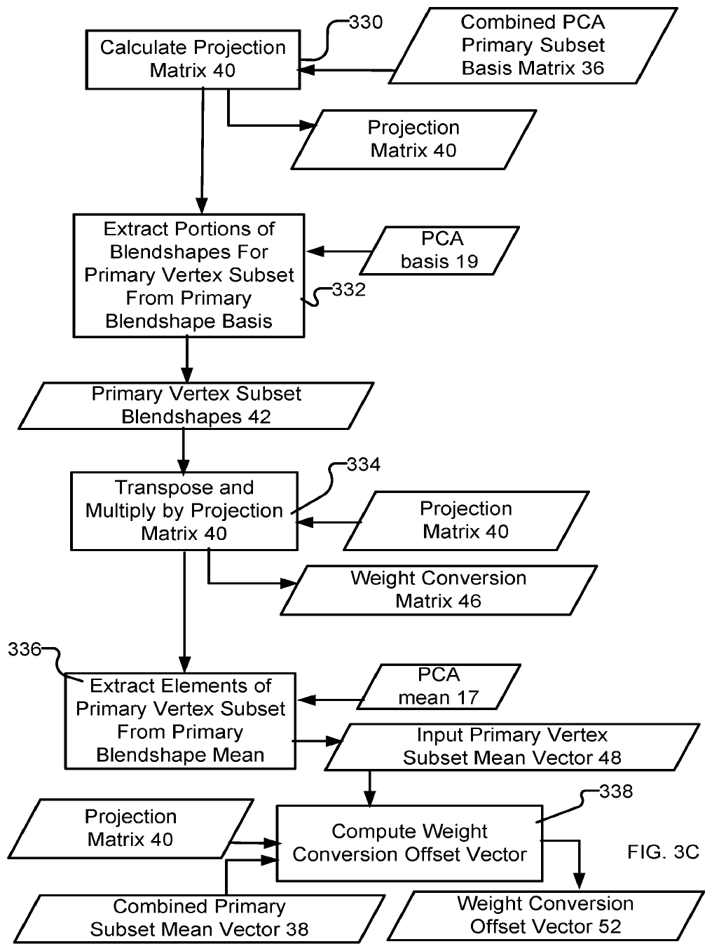

FIGS. 3A to 3C depict an exemplary, non-limiting method 300 for training a secondary facial component animation model (e.g. secondary facial component animation model 132 shown in FIG. 10) using training data 21 according to one embodiment of the invention. Method 300 may receive, as input, training data 21 from method 200 which may comprise primary face animation 16, secondary facial component animation 18 and primary facial geometry vertex subset 20. Method 300 may output secondary facial component animation model 132 which may, in the illustrated embodiment, comprise: weight-conversion matrix 46 and weight-conversion vector 52, as described in more detail below.

In the illustrated embodiment, method 300 begins in step 302 which involves obtaining (or generating) a principal component analysis (PCA) decomposition 25 of primary face animation 16. It will be understood that the step 302 matrix decomposition (which is illustrated and described herein as being a PCA decomposition) could, in general, comprise any suitable form of matrix decomposition technique or dimensionality reduction technique (e.g. independent component analysis (ICA), non-negative matrix factorization (NMF) and/or the like). For brevity, step 302, its output matrix decomposition 25 and the components mean vector 17, basis matrix 19 and weights 23 are described herein as being a PCA decomposition (e.g. PCA decomposition step 302, PCA decomposition 25, PCA mean vector 17, PCA basis matrix 19 and PCA weights 23). However, unless the context dictates otherwise, these elements should be understood to incorporate the process and outputs of other forms of matrix decomposition and/or dimensionality reduction techniques. PCA decomposition 25 may comprise a PCA mean vector 17, a PCA basis matrix 19 and a set of PCA weights 23. In some embodiments, PCA decomposition 25 may be obtained a priori, in which case PCA decomposition 25 need not be generated as a part of method 300, but instead may be merely obtained as input to method 300. For the purposes of the block 302 PCA decomposition, primary face animation 16 may be represented in matrix format by a matrix X with dimensionality [f, 3n] where f is the number of frames in primary face animation 16, n is the number of vertices in the primary face geometry and 3n represents 3 coordinates (e.g. the {x, y, z} dimensions) of each vertex.

PCA mean vector 17 may comprise a vector \vec{μ} of dimensionality 3n, where n is the number of vertices in the topology of primary face geometry (i.e. the number of vertices in each frame of primary face animation 16). Each element of PCA mean vector 17 may comprise the mean of a corresponding column of primary face animation matrix X over the f frames of primary face animation 16. Since PCA mean vector 17 is a vector of length 3n, PCA mean vector 17 may be considered to define a primary face geometry. In some embodiments, such as, for example, where PCA decomposition 25 is performed prior to method 300, PCA mean vector 17 may be the same as or equivalent to primary neutral geometry 10 described in connection with method 200 used to obtain training data 21.

PCA basis matrix 19 may comprise a matrix V of dimensionality [k, 3n], where k is a number of blendshapes (also referred to as eigenvectors) used in the PCA decomposition, where k≤min(f, 3n]. Each of the k rows of PCA basis matrix 19 has 3n elements and may be referred to as a blendshape. The number k may be referred to as the number of blendshapes. The number k of blendshapes is a parameter of the PCA decomposition process (step 302) and may be configurable by selecting the number k outright, by selecting a percentage of the variance in primary face animation 16 that should be explained by the k blendshapes and/or the like. The number k may depend on the computational budget for real-time operation of methods 101 (FIG. 1B) and 121 (FIG. 1C). The higher the number k, the more faithfully PCA decomposition 25 can recreate all of the frames of primary face animation 16.

PCA weights 23 may comprise a matrix Z of dimensionality [f, k] where f is the number of frames in primary face animation 16 and k is the number of blendshapes, as discussed above. Each row the matrix Z of PCA weights 23 is a set (vector) of k weights corresponding to a particular frame of primary face animation 16.

The frames of primary face animation 16 can be approximately reconstructed from PCA decomposition 25 according to \hat{X}=ZV+\vec{Ψ}, where \hat{X} is a matrix of dimensionality [f, 3n] in which each row of \hat{X} represents an approximate reconstruction of one frame of primary face animation 16, Z is the matrix of dimensionality [f, k] corresponding to PCA weights 23, V is the matrix of dimensionality [k, 3n] corresponding to PCA basis 19 and \vec{Ψ} is a matrix of dimensionality [f, 3n], where each row of \vec{Ψ} is \vec{μ} and \vec{μ} is the vector of dimensionality 3n corresponding to PCA mean vector 17. An individual frame of primary face animation 16 can be approximately constructed according to \hat{x}=\vec{z}V+\vec{μ}, where \hat{x} is the reconstructed frame comprising a vector of dimension 3n, \vec{z} is the set (vector) of weights having dimension k selected as a row of PCA weight matrix Z (PCA weights 23).

In some cases, block 302 may not be required. For example, in some cases primary face animation 16 used to generate training data 21 (see FIG. 2) and used as input to training method 300 may already have a blendshape decomposition. This blendshape decomposition need not strictly be a PCA decomposition and the elements (weights, basis and mean) need not be the same as PCA weights 23, PCA basis 19 and PCA mean 17 output from block 302. For example, primary face animation 16 may be provided in the form of FACs blendshapes or a blendshape format that is the result of any suitable form of matrix decomposition technique or dimensionality reduction technique (e.g. independent component analysis (ICA), non-negative matrix factorization (NMF) and/or the like). Method 300 may proceed with the weights, basis and mean from this other decomposition, which may be provided as inputs to method 300. For brevity, this description uses the terms PCA weights 23, PCA basis 19 and PCA mean 17. However, unless the context dictates otherwise, it should be understood that weights 23, basis 19 and mean 17 could be replaced by the weights, basis and mean of some other decomposition of primary face animation 16. Such weights, basis and mean of some other decomposition of primary face animation 16 may be received as inputs to the methods described herein.

Step 312 of method 300 comprises generating primary vertex subset animation 22 based on primary face animation 16 and primary facial geometry vertex subset 20. Because each element of primary facial geometry vertex subset 20 corresponds to a vertex of the primary facial geometry (e.g. primary facial component vertex subset 20 comprises the indices of p≤n vertices of facial geometry used in each frame of primary face animation 16), the animation of only the p vertices of primary facial geometry vertex subset 20 may be extracted from primary face animation 16 by extracting the columns of primary face animation 16 matrix X that correspond to the p vertices of primary facial geometry vertex subset 20. Primary vertex subset animation 22 may be represented by a matrix of dimension [f, 3p].

Step 314 of method 300 comprises combining primary vertex subset animation 22 with secondary facial component animation 18 to generate a combined animation matrix 24. Where primary vertex subset animation 22 is represented by a matrix of dimensionality [f, 3p] and secondary facial component animation 18 is represented by a matrix of dimensionality [f, 3m], the step 314 combination of primary vertex subset animation 22 with secondary facial component animation 18 may comprise concatenating the dimensions representing the vertices such that combined animation 24 is a matrix having dimensionality of [f, 3(m+p)].

Method 300 proceeds to step 316 which comprises performing another PCA decomposition on combined animation matrix 24 to obtain combined PCA decomposition 37. Step 316 may be similar to step 302 described above, except that step 316 works with combined animation matrix 24. As discussed above, combined animation matrix 24 comprises a matrix W which has dimensionality [f, 3(m+p)], where each row of combined animation matrix 24 represents a frame and includes 3 coordinates (e.g. the {x, y, z} positions) of the m secondary component vertices of secondary component animation 18 and the p vertices of primary facial geometry subset animation 22. The output of the step 316 combined PCA decomposition 37 comprises: combined PCA mean 31, combined PCA basis 33 and combined PCA weights 35. As explained in more detail below, combined PCA weights 35 are not required for performing method 300, but are an incidental output of the step 316 PCA decomposition. It will be understood that the step 316 matrix decomposition (which is illustrated and described herein as being a PCA decomposition) could, in general, comprise any suitable form of matrix decomposition technique or dimensionality reduction technique (e.g. independent component analysis (ICA), non-negative matrix factorization (NMF) and/or the like). For brevity, step 316, its output matrix decomposition 37 and the components mean vector 31, basis matrix 33 and weights 35 are described herein as being a PCA decomposition (e.g. PCA decomposition step 316, combined PCA decomposition 37, combined PCA mean vector 31, combined PCA basis matrix 33 and combined PCA weights 35). However, unless the context dictates otherwise, these elements should be understood to incorporate the process and outputs of other forms of matrix decomposition and/or dimensionality reduction techniques. Furthermore, the methods herein describe further processing the elements of decomposition 37 to generate related components, such as, by way of non-limiting example, secondary component basis matrix 32, secondary component mean vector 34, combined primary subset basis matrix 36, combined primary subset mean vector 38, and such further derived components are non-limited to those derived from PCA decomposition and such further derived components should be understood to be derivable from other (non-PCA) matrix decompositions and/or dimensionality reduction techniques in a similar manner.

Combined PCA mean 31 comprises a vector \vec{ω} of dimensionality 3(m+p). Each element of combined PCA mean vector 31 may comprise the mean of a corresponding column of combined animation matrix W over the f frames of combined animation 24. Combined PCA basis 33 comprises a matrix M of dimensionality [q, 3(m+p)], where q is a number of combined blendshapes (also referred to as eigenvectors) used in the PCA decomposition, where q≤min(f,3(m+p)). Each of the q rows of combined PCA basis matrix 33 has 3(m+p) elements and may be referred to as a combined blendshape. The number q may be referred to as the number of combined blendshapes. The number q of combined blendshapes is a parameter of the PCA decomposition process (step 316) and may be configurable by selecting the number q outright, by selecting a percentage of the variance in combined animation 24 that should be explained by the q combined blendshapes and/or the like. The number q may depend on the computational budget for real-time operation of methods 101 (FIG. 1B) and 121 (FIG. 1C). The higher the number q, the more faithfully combined PCA decomposition 37 can recreate all of the frames of combined animation 24. Combined PCA weights 35 may comprise a matrix Y of dimensionality [f, q]. Each row the matrix Y of PCA weights 35 is a set (vector) of q weights corresponding to a particular frame of combined animation 24.

The frames of combined animation 24 can be approximately reconstructed from PCA decomposition 25 according to Ŵ=YM+\vec{Π}, where Ŵ is a matrix of dimensionality [f, 3(m+p)] in which each row of Ŵ represents an approximate reconstruction of one frame of combined animation 24, Y is the matrix of dimensionality [f, q] corresponding to combined PCA weights 35, M is a matrix of dimensionality [q, 3(m+p)] corresponding to combined PCA basis 33 and \vec{Π} is a matrix of dimensionality [f, 3(m+p)], where each row of \vec{Π} is \vec{ω} and \vec{ω} is the vector of dimensionality 3(m+p) corresponding to combined PCA mean vector 31. An individual frame of combined animation 24 can be approximately constructed according to ŵ=\vec{y}M+\vec{ω}, where ŵ is the reconstructed frame comprising a vector of dimension 3(m+p), \vec{y} is the set (vector) of weights having dimension q selected as a row of PCA weight matrix Y (combined PCA weights 35).

Method 300 then proceeds to step 322 which comprises extracting, from combined PCA basis matrix 33, the columns corresponding to the m vertices of the secondary component to yield secondary component basis matrix 32. As discussed above, combined PCA basis matrix 33 comprises a matrix M of dimensionality [q, 3(m+p)]. It will be appreciated that 3m of the columns of combined PCA basis matrix 33 correspond to the secondary component. These 3m columns are extracted from combined PCA basis matrix 33 in step 322 to yield secondary component basis matrix 32 which has dimensionality [q, 3m]. Secondary component basis matrix 32 may be referred to herein as secondary component basis matrix D of dimensionality [q, 3m]. It will be appreciated that each row of secondary component basis matrix 32 (secondary component basis matrix D) may be considered to be a blendshape for the secondary component under consideration.

Method 300 then proceeds to step 324 which comprises extracting, from combined PCA mean 31, the elements corresponding to the m vertices of the secondary component to yield secondary component mean vector 34. As discussed above, combined PCA mean vector 31 comprises a vector \vec{ω} of dimensionality 3(m+p). It will be appreciated that 3m of the elements of combined PCA mean vector 31 correspond to the secondary component. These 3m elements are extracted from combined PCA mean vector 31 in step 324 to yield secondary component mean vector 34 which has dimensionality 3m. Secondary component mean vector 34 may also be referred to herein as secondary component mean vector a having dimensionality 3m.

Method 300 then proceeds to step 326 which is analogous to step 322 except that step 326 involves extracting, from combined PCA basis matrix 33, the columns corresponding to the p vertices of the primary vertex subset 20 to yield combined primary subset basis matrix 36. As discussed above, combined PCA basis matrix 33 comprises a matrix M of dimensionality [q, 3(m+p)]. It will be appreciated that 3p of the columns of combined PCA basis matrix 33 correspond to the primary vertex subset 20. These 3p columns are extracted from combined PCA basis matrix 33 in step 326 to yield combined primary subset basis matrix 36 which has dimensionality [q, 3p]. It will be appreciated that each row of combined primary subset basis matrix 36 may be considered to be a blendshape for the primary vertex subset.

Method 300 then proceeds to step 328 which is analogous to step 324 except that step 328 involves extracting, from combined PCA mean 31, the elements corresponding to the p vertices of primary vertex subset 20 to yield combined primary subset mean vector 38 (combined PCA primary subset mean vector \vec{ω}*). As discussed above, combined PCA mean vector 31 comprises a vector \vec{ω} of dimensionality 3(m+p). It will be appreciated that 3p of the elements of combined PCA mean vector 31 correspond to primary vertex subset 20. These 3p elements are extracted from combined PCA mean vector 31 in step 328 to yield combined primary subset mean vector 38 (combined PCA primary subset mean vector \vec{ω}*) which has dimensionality 3p.

Method 300 then proceeds to step 330 which comprises generating projection matrix 40 from combined primary subset basis matrix 36 which can project, albeit with some error, any given configuration of positions (or offsets from neutral) for the p vertices of primary feature vertex subset 20 into a set of weights for combined primary subset basis matrix 36. Projection matrix 40 may be determined by minimizing the least-squares reconstruction error associated with using combined primary subset basis matrix 36 according to P=(A^{T}A)⁻¹A^{T}, where A^{T} is combined primary subset basis matrix 36 and P is projection matrix 40. The projection matrix P (projection matrix 40) has dimensionality [q, 3p] which is the same dimensionality as primary subset basis matrix A^{T} (combined primary subset basis matrix 36). When the projection matrix P is right multiplied by a given configuration of positions (or offsets) for the p vertices of primary vertex subset 20 (i.e. a column vector of dimension 3p), the result is a vector \vec{b} of dimension q which may be considered to be a set of weights for combined primary subset basis matrix 36. That is, when combined primary subset basis matrix 36 (A^{T}) is left multiplied by this vector \vec{b} (as a row vector), the product \vec{b}A^{T} yields a set (vector) of dimension 3p which corresponds to positions (or offsets) of the p vertices of primary feature vertex subset 20 which minimize the least squares error relative to the original input positions (or offsets) of these p vertices of primary feature vertex subset 20. Projection matrix P (projection matrix 40) may be described as the matrix that projects a vector \vec{b} onto the space spanned by the rows of A^{T} where \vec{b} and A^{T} have the meanings described above.

Method 300 then proceeds to step 332 which involves extracting the portions of each PCA blendshape corresponding to primary vertex subset 20 from PCA basis 19 (FIG. 3A) corresponding to primary face animation 16 to yield primary vertex subset blendshapes 42 (also referred to herein as input primary vertex subset basis 42). As discussed above, PCA basis 19 comprises a matrix V of dimensionality [k, 3n], where k is a number of blendshapes (also referred to as eigenvectors) used in the step 302 PCA decomposition and n is the number of vertices in primary face geometry. Each of the k rows of PCA basis matrix 19 has 3n elements and may be referred to as a blendshape. Step 332 comprises extracting the columns of PCA basis 19 (matrix V) which correspond to the p vertices of primary vertex subset 20 to build a matrix of primary vertex subset blendshapes 42 (input primary vertex subset basis 42). The matrix of primary vertex subset blendshapes 42 (input primary vertex subset basis 42) comprises a matrix V* having dimensionality [k, 3p], where the number (3p) of columns corresponds to the 3 coordinates (e.g. {x, y, z} dimensions) of the p vertices of primary vertex subset 20. As discussed above, in some cases the step 302 PCA decomposition is not required and some other form of blendshape decomposition (including blendshapes (or a blendshape basis matrix), weights and mean vector) of primary face animation 16 may be provided (e.g. as an input to method 300). In such cases, the basis matrix of that other blendshape decomposition may be used (in the place of PCA basis 19) to extract primary vertex subset blendshapes 42 (input primary vertex subset basis 42). Such primary vertex subset blendshapes 42 (input primary vertex subset basis 42) may also be represented by a matrix of dimensionality [k, 3p] where k is the number of blendshapes in such other decomposition and may be referred to herein as V*. It should be noted that the number k of blendshapes in such other decomposition is used for convenience and need not be the same as the number k of blendshapes in the PCA decomposition of optional step 302.

Method 300 then proceeds to step 334 which involves transposing the matrix V* of primary vertex subset blendshapes 42 (input primary vertex subset basis 42) and right multiplying projection matrix 40 (P) by this transposed matrix V*^{T}. The result of this step 334 product (C=PV*^{T}) is weight-conversion matrix 46 (weight conversion matrix C) having dimensionality [q, k] where k is the number of principal components in the step 302 PCA decomposition and q is the number of principal components in the step 316 combined PCA decomposition. Weight-conversion matrix 46 is part of secondary facial component animation model 132 and is used in the inference steps of methods 101, 121 (FIGS. 1B, 1C) to determine secondary geometry weights 116 used to construct the geometry of the secondary feature for which methods 101, 121, 300 are performed.

Method 300 then proceeds to step 336 which, in a manner analogous to step 332, involves extracting the elements corresponding to primary vertex subset 20 from PCA mean vector 17 (FIG. 3A) to yield primary vertex subset mean vector 48 (also referred to herein as input primary vertex subset mean vector 48). As discussed above, PCA mean vector 17 comprises a vector μ of dimensionality 3n. Step 336 comprises extracting the elements of PCA mean vector 17 (vector \vec{μ}) which correspond to the p vertices of primary vertex subset to build a input primary vertex subset mean vector 48. The vector of primary vertex subset elements comprises a vector re having dimensionality 3p, where the number (3p) of rows corresponds to 3 coordinates (e.g. the {x, y, z} dimensions) for the p vertices of primary vertex subset 20. As discussed above, in some cases the step 302 PCA decomposition is not required and some other form of blendshape decomposition of primary face animation 16 may be provided (e.g. as an input to method 300). In such cases, the mean or neutral of that other blendshape decomposition may be used to extract input primary vertex subset mean vector 48. Such an input primary vertex subset mean vector 48 also has dimensionality 3p and may be referred to herein as \vec{μ}*.

Method 300 then proceeds to step 338 which involves right multiplying projection matrix 40 (P) by the difference between input primary vertex subset mean vector 48 (vector \vec{μ}*) and combined primary subset mean vector 38 (vector \vec{ω}*) in column form. The result of this step 338 product (\vec{γ}=P(\vec{μ}*−\vec{ω}*)) is weight-conversion offset vector 52 (weight conversion offset vector \vec{γ}) having dimensionality q where q is the number of principal components in the step 316 combined PCA decomposition. Weight-conversion offset vector 52 (weight conversion offset vector \vec{γ}) is part of secondary facial component animation model 132 and is used in the inference steps of methods 101, 121 (FIGS. 1B, 1C) to determine secondary geometry weights 116 used to construct the geometry of the secondary feature for which methods 101, 121, 300 are performed. In the case where input primary vertex subset mean vector 48 (\vec{μ}*) is derived from a PCA decomposition in step 302, then input primary vertex subset mean vector 48 (\vec{μ}*) will be the same as combined primary subset mean vector 38 (vector \vec{ω}*) obtained in step 328, in which case weight-conversion offset vector 52 (weight conversion offset vector \vec{γ}) will be zero. In the general case, however, where input primary vertex subset mean vector 48 (\vec{μ}*) is derived from some other form of blendshape decomposition, then input primary vertex subset mean vector 48 (\vec{μ}*) will be different than combined primary subset mean vector 38 (vector \vec{ω}*) obtained in step 328 and weight-conversion offset vector 52 (weight conversion offset vector \vec{γ}) will be non-zero.

Returning now to the method 101 for inferring secondary facial component animation 114 from primary facial animation 112 using secondary facial component model 132 shown in FIGS. 1B and 10, we consider the step 120 process according to a particular embodiment in more detail. As discussed above and shown in FIGS. 1B and 10, step 120 is performed once for each frame of primary face animation 112. As discussed above, each frame of primary face animation 112 may be represented by a set of k blendshape weights 112′ (i.e. a vector \vec{g} of dimension k), where it is assumed that PCA decomposition 25 (having k blendshapes) is used to represent primary face animation 112. So, for a particular frame, step 122 (FIG. 10) involves right multiplying weight-conversion matrix 46 (weight conversion matrix C) having dimensionality [q, k] by this k dimensional weight vector \vec{g} (representing a frame of primary facial animation 112) by to yield a product vector 136 (product vector \vec{s}) having dimensionality q. Then, step 124 involves adding weight-conversion offset vector 52 (weight conversion offset vector \vec{γ}) to product vector 136 (product vector \vec{s}) to yield a vector of secondary component weights 116 (secondary component weight vector \vec{t}, where \vec{t}=\vec{s}+\vec{γ}) having dimensionality q. The vector \vec{t} of secondary component weights 116 represents one frame of secondary facial component animation 114.

As shown in FIG. 1B and alluded to above, method 101 may optionally comprise generating and/or rendering images on a frame-by-frame basis using secondary geometry weights 116 (in step 130) and/or generating and/or rendering some or all of the frames of secondary facial component animation 114 (in step 140). Generating and/or rendering image frames in steps 130, 140 may be performed in real time (e.g. a plurality of times per second) using suitable animation software, such as Unreal Engine™ produced by Epic Games and/or the like. Generating and/or rendering image frames in steps 130, 140 may involve rendering the primary face geometry (e.g. frames of primary facial animation 112) the geometries of one or more secondary facial components (e.g. secondary geometry weights 116 or frames of secondary facial component animation 114) as well as other aspects of a scene. For the purpose of this disclosure, the description of generating and/or rendering is limited to describing how the three-dimensional vertex geometry of secondary facial components is recreated (computed) from each set of secondary geometry weights 116 (for generating/rendering a single frame in step 130) and from a plurality of frames of secondary geometry weights 116 in secondary facial component animation 114 (for generating/rendering multiple frames in step 140).

As discussed above, each iteration of step 120 generates a vector \vec{t} of secondary component weights 116 (having dimension q) that correspond to a corresponding frame of primary facial animation 112. This vector \vec{t} of secondary component weights 116 may be used to construct the vertex geometry (independent or offset from neutral) for the secondary facial component for a particular frame using secondary component basis matrix 32 (secondary component basis matrix D) and secondary component mean vector 34 (secondary component mean vector \vec{α})—see steps 322 and 324 of method 300 (FIG. 3B). Secondary component basis matrix 32 (secondary component basis matrix D) and secondary component mean vector 34 (secondary component mean vector \vec{α}) may form part of secondary facial component model 132 (see FIG. 1A) or may otherwise be exported so as to be available for the performance of step 130. As discussed above, secondary component basis matrix 32 (secondary component basis matrix D) has dimensionality [q, 3m] and secondary component mean vector 34 (secondary component mean vector \vec{α}) has dimensionality 3m. The vertex geometry (a vector \vec{α} having dimensionality 3m) of a frame of secondary component geometry may be reconstructed in step 130 according to \vec{a}=\vec{t}D+\vec{α}. The product of each vector \vec{t} of secondary component weights 116 (dimensionality q) with secondary component basis matrix D (dimensionality [q, 3m]) yields a vector of dimensionality 3m which may then be added to secondary component mean vector a to yield a vector a of dimensionality 3m which may correspond to three coordinates (e.g. the {x, y, z} dimensions) of one frame of the m vertices of the secondary component geometry.

This process can be repeated on a frame by frame basis in step 130 to generate and/or render the individual frames of secondary facial component animation 14. Since, for each frame of primary face animation 112, the inference of method 101 involves only one matrix multiplication (step 122) and one vector addition (step 124) to yield secondary component weights 116 and then one further matrix multiplication and one further vector addition to render the 3m vertex geometries of the secondary component, this process of inferring and rendering the 3m vertex geometries of the secondary component can be performed in real-time.

This three-dimensional vertex reconstruction process can be extended to multiple frames for generating and/or rendering secondary facial component animation 114 in step 140. Secondary facial component animation 114 may be represented by a matrix T having dimensionality [f, q] corresponding to f frames of secondary component weights 116 (each having dimension q). The vertex geometry (a matrix A having dimensionality [f, 3m]) for the f frames of secondary facial component animation 114 may be reconstructed in step 140 according to A=TD+Φ where D is secondary component basis matrix 32 (having dimensions [q, 3m]) and Φ is a [f, 3m] dimensional matrix where each of its f rows are secondary component mean vector 34 (secondary component mean vector \vec{α}).

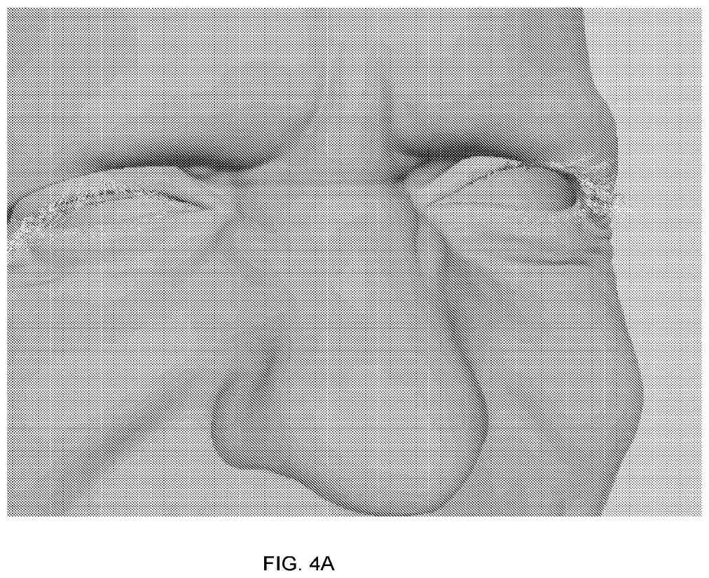

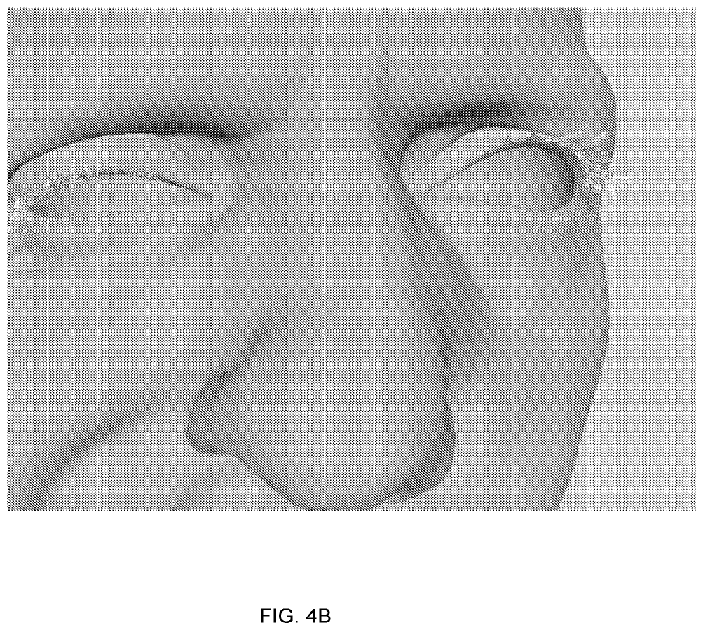

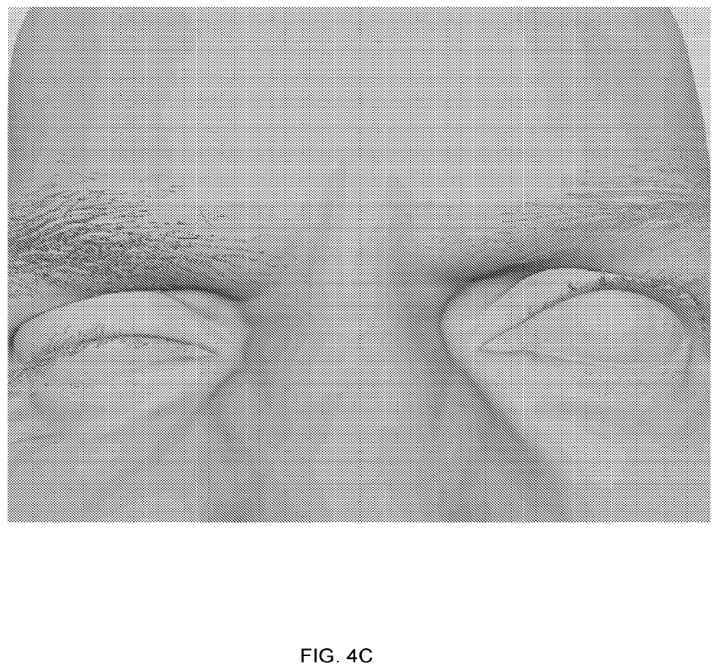

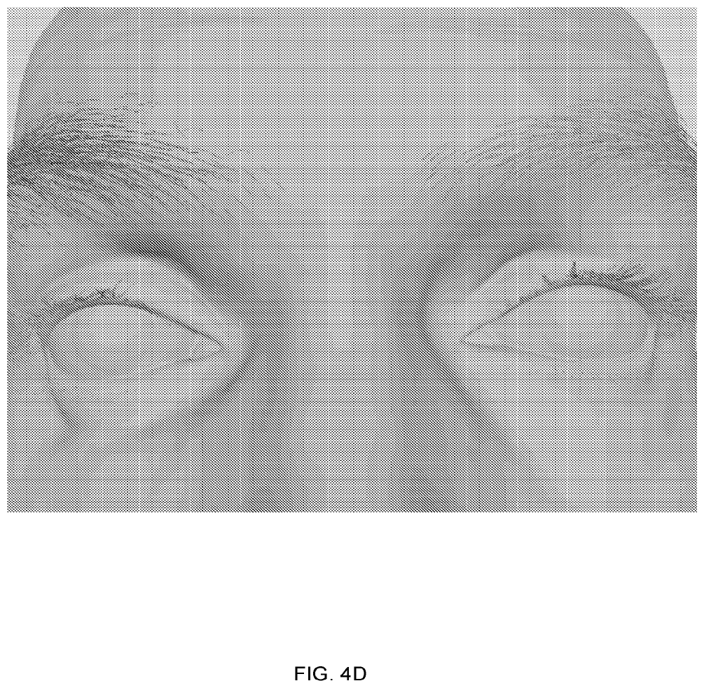

FIGS. 4A to 4D depict various representations of renderings made using the system 82 of FIG. 1A and the animation methods 101, 121 of FIGS. 1B and 1C comprising primary facial geometries and the corresponding geometries of secondary facial components (in this case the upper and lower, right and left eyelashes and right and left eyebrows). It can be seen from FIGS. 4A to 4D that the secondary component geometries of the eyelashes and eyebrows move in a realistic manner to reflect the different primary facial geometries of the face.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.
Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.
Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”)). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Software and other modules may reside on servers, workstations, personal computers, tablet computers, image data encoders, image data decoders, PDAs, color-grading tools, video projectors, audio-visual receivers, displays (such as televisions), digital cinema projectors, media players, and other devices suitable for the purposes described herein. Those skilled in the relevant art will appreciate that aspects of the system can be practised with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics (e.g., video projectors, audio-visual receivers, displays, such as televisions, and the like), set-top boxes, color-grading tools, network PCs, mini-computers, mainframe computers, and the like.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

The invention comprises a number of non-limiting aspects. Non-limiting aspect of the invention comprise:
1. A method for generating one or more frames of computer-based facial animation, the method comprising:
   obtaining, at a processor, a plurality of frames of facial animation training data, the facial animation training data comprising, for each of the plurality of frames of facial animation training data:
      a training representation of a training primary face geometry comprising geometric information for a training plurality of primary face vertices; and
      a corresponding training representation of a training secondary facial component geometry comprising geometric information for a training plurality of secondary facial component vertices; and
the facial animation training data further comprising a subset index comprising indices of a subset of the training plurality of primary face vertices;
   training, by the processor, a secondary facial component model using the facial animation training data;
   obtaining, at the processor, one or more frames of primary face animation, each of the one or more frames of primary face animation comprising an animation representation of an animation primary face geometry comprising geometric information for an animation plurality of primary face vertices;
   for each of the one or more frames of primary face animation:
   generating, by the processor, a corresponding frame of secondary facial component animation based on the frame of primary face animation and the secondary facial component model, the corresponding frame of the secondary facial component animation comprising an animation representation of an animation secondary facial component geometry comprising geometric information for an animation plurality of secondary facial component vertices wherein the secondary facial component geometry is based on the animation primary face geometry.
2. The method of aspect 1 or any other aspect herein wherein the animation representation of the animation primary face geometry comprises, for each of the one or more frames of primary face animation, a plurality of k primary face animation blendshape weights.
3. The method of aspect 2 or any other aspect herein wherein the animation representation of the animation secondary facial component geometry comprises, for each corresponding frame of secondary facial component animation, a plurality of q secondary facial component animation blendshape weights.
4. The method of aspect 3 or any other aspect herein wherein the secondary facial component model comprises a weight-conversion matrix C and wherein, for each of the one or more frames of primary face animation, generating the corresponding frame of secondary facial component animation based on the frame of primary face animation and the secondary facial component model comprises right multiplying the weight conversion matrix C by the plurality of k primary face animation blendshape weights for the frame of primary face animation to yield, within an offset vector, the plurality of q secondary facial component animation blendshape weights for the corresponding frame of secondary facial component animation.
5. The method of aspect 4 or any other aspect herein wherein the secondary facial component model comprises a weight-conversion offset vector \vec{γ} and wherein, for each of the one or more frames of primary face animation, generating the corresponding frame of secondary facial component animation based on the frame of primary face animation and the secondary facial component model comprises adding the weight-conversion offset vector \vec{γ} to a product of the right multiplication of the weight conversion matrix C by the plurality of k primary face animation blendshape weights for the frame of primary face animation to yield the plurality of q secondary facial component blendshape weights for the corresponding frame of secondary facial component animation.
6. The method of any one of aspects 1 to 5 or any other aspect herein comprising:
   performing the steps of:
      obtaining, at the processor, one or more frames of primary face animation; and,
      for each of the one or more frames of primary face animation,
   generating, by the processor, a corresponding frame of secondary facial component animation based on the frame of primary face animation and the secondary facial component model;
in real time.
7. The method of any one of aspects 1 to 6 or any other aspect herein comprising:
   performing the steps of:
      obtaining, at the processor, one or more frames of primary face animation; and,
      for each of the one or more frames of primary face animation,
generating, by the processor, a corresponding frame of secondary facial component animation based on the frame of primary face animation and the secondary facial component model;
at a rate at least as fast as an animation frame rate for each of the one or more frames.
8. The method of any one of aspects 1 to 7 or any other aspect herein comprising:
   performing the steps of:
      obtaining, at the processor, one or more frames of primary face animation; and,
      for each of the one or more frames of primary face animation,
   generating, by the processor, a corresponding frame of secondary facial component animation based on the frame of primary face animation and the secondary facial component model;
at a rate of at least 15 frames per second.
9. The method of any one of aspects 1 to 8 or any other aspect herein comprising:
   performing the steps of:
      obtaining, at the processor, one or more frames of primary face animation; and,
      for each of the one or more frames of primary face animation,
   generating, by the processor, a corresponding frame of secondary facial component animation based on the frame of primary face animation and the secondary facial component model;
at a rate of at least 24 frames per second.
10. The method of any one of aspects 1 to 9 or any other aspect herein wherein obtaining the plurality of frames of facial animation training data comprises receiving the training representation of the training primary face geometry and the training representation of the training second facial component geometry from a computer-implemented animation rig.
11. The method of any one of aspects 1 to 9 or any other aspect herein wherein obtaining the plurality of frames of facial animation training data comprises receiving the training representation of the training primary face geometry and the training representation of the training second facial component geometry at least in part from user input.
12. The method of any one of aspects 1 to 11 or any other aspect herein wherein the subset index comprises indices of a subset of p primary face vertices (p≤n where n is a number of primary face vertices) that are selected by a user as being relevant to the secondary facial component geometry.
13. The method of any one of aspects 1 to 11 or any other aspect herein wherein the subset index comprises indices of a subset of p primary face vertices (p≤n where n is a number of primary face vertices) that are proximate (e.g. within a proximity threshold or selected as the most proximate p primary face vertices) to the secondary facial component geometry.
14. The method of any one of aspects 1 to 11 or any other aspect herein wherein the subset index comprises indices of a subset of p primary face vertices (p≤n where n is a number of primary face vertices) determined to be relevant to the secondary facial component geometry.
15. The method of any one of aspects 12 to 14 or any other aspect wherein obtaining the plurality of frames of facial animation training data comprises at least one of obtaining or converting the training representation of the training primary face geometry to, for each of the one or more frames of facial animation training data, a plurality of n primary face training vertex locations, each primary face training vertex location comprising 3 coordinates.
16. The method of any one of aspects 12 to 14 or any other aspect wherein obtaining the plurality of frames of facial animation training data comprises at least one of obtaining or converting the training representation of the training primary face geometry to, for each of the one or more frames of facial animation training data, locations for each of the subset of p primary face vertices, each of the p primary face vertices comprising 3 coordinates.
17. The method of any one of aspects 15 or 16 or any other aspect herein wherein obtaining the plurality of frames of facial animation training data comprises at least one of obtaining or converting the training representation of the training secondary facial component geometry to, for each of the one or more frames of facial animation training data, a plurality of m secondary facial component training vertex locations, each secondary facial component training vertex location comprising 3 coordinates.
18. The method of any one of aspects 15 to 17 or any other aspect herein wherein training the secondary facial component model using the facial animation training data comprises:
   performing a matrix decomposition (e.g. principal component analysis (PCA), independent component analysis (ICA), non-negative matrix factorization (NMF), any other suitable matrix decomposition or dimensionality reduction technique and/or the like) of a combined training matrix which includes:
      a plurality of f frames, each of the plurality of f frames comprising p primary face training vertex locations corresponding to the subset of p primary face vertices; and m secondary facial component training vertex locations;
to yield a combined matrix decomposition;
   generating the secondary facial component model based on the combined matrix decomposition.
19. The method of aspect 18 or any other aspect herein wherein the combined matrix decomposition comprises:
   a combined basis matrix having dimensionality [q, 3(m+p)] where q is a number of blendshapes for the combined matrix decomposition;
   a combined mean vector having dimensionality 3(m+p).
20. The method of aspect 19 or any other aspect herein wherein generating the secondary facial component model based on the combined matrix decomposition comprises generating, from the combined matrix decomposition:
   a combined primary subset basis matrix having dimensionality [q, 3p] by extracting 3p vectors of length q (e.g. 3p columns) from the combined basis matrix which correspond to the subset of p primary face vertices; and
   a combined primary subset mean vector having dimensionality 3p by extracting 3p elements from the combined mean vector which correspond to the subset of p primary face vertices.
21. The method of aspect 20 or any other aspect herein wherein generating the secondary facial component model based on the combined matrix decomposition comprises generating, from the combined matrix decomposition:
   a secondary facial component basis matrix having dimensionality [q, 3m] by extracting 3m vectors of length q (e.g. 3m columns) from the combined basis matrix which correspond to the m secondary facial component vertices; and
   a secondary facial component mean vector having dimensionality 3m by extracting 3m elements from the combined mean vector which correspond to the m secondary facial component vertices.
22. The method of aspect 21 or any other aspect herein wherein generating the secondary facial component model based on the combined matrix decomposition comprises:
   generating a projection matrix P having dimensionality [q, 3p] based on the combined primary subset basis matrix, wherein the projection matrix P will project a vector of 3p positions or offsets of the subset of p primary face vertices into a corresponding set of weights for the combined primary subset basis matrix; and
   generating a weight-conversion matrix C that forms part of the secondary facial component model based at least in part on the projection matrix P.
23. The method of aspect 22 or any other aspect herein wherein generating the projection matrix P comprises selecting the projection matrix P that will minimize an error associated with converting the weights from the combined primary subset basis matrix back to the 3p positions or offsets of (e.g. reconstructing) the subset of p primary face vertices.
24. The method of aspect 23 or any other aspect herein wherein generating the projection matrix P comprises selecting the projection matrix P that will minimize a least squares error associated with converting the weights for the combined primary subset basis matrix back to the 3p positions or offsets of (e.g. reconstructing) the subset of p primary face vertices using the combined primary subset basis matrix.
25. The method of any one of aspects 23 to 24 or any other aspect herein wherein generating the projection matrix P comprises calculating the projection matrix P according to P=(A^{T}A)⁻¹A^{T} where A^{T} is the combined primary subset basis matrix.
26. The method of any one of aspects 22 to 25 or any other aspect herein wherein generating the weight-conversion matrix C that forms part of the secondary facial component model based at least in part on the projection matrix P comprises:
   determining a matrix of primary vertex subset blendshapes V* having dimensionality [k, 3p] based on the primary face animation; and
   generating the weight-conversion matrix C according to C=PV*^{T}.
27. The method of aspect 26 or any other aspect herein wherein:
   the animation representation of the animation primary face geometry comprises a primary face blendshape matrix of dimensionality [k, 3n], where k represents a number of primary face blendshapes in a blendshape decomposition of the animation primary face geometry and n represents a number of vertices of the animation primary face geometry; and
   determining the matrix of primary vertex subset blendshapes V* based on the primary face animation comprises extracting, from the primary face blendshape matrix, the 3p vectors of length k (e.g. 3p columns) which correspond to the subset of p primary face vertices.
28. The method of any one of aspects 22 to 27 or any other aspect herein wherein:
   the animation representation of the animation primary face geometry comprises, for each of the one or more frames of primary face animation, a plurality of k primary face animation blendshape weights;
   the animation representation of the animation secondary facial component geometry comprises, for each of the one or more frames of primary face animation, a plurality of q secondary facial component animation blendshape weights; and
   for each of the one or more frames of primary face animation, generating the corresponding frame of secondary facial component animation based on the frame of primary face animation and the secondary facial component model comprises right multiplying the weight-conversion matrix C by the plurality of k primary face animation blendshape weights for the frame of primary face animation to yield, within an offset vector, a vector comprising the plurality of q secondary facial component animation blendshape weights for the corresponding frame of secondary facial component animation.
29. The method of any one of aspects 22 to 28 or any other aspect herein wherein generating the secondary facial component model based on the combined decomposition comprises generating a weight-conversion offset vector \vec{γ} that forms part of the secondary facial component model based at least in part on the projection matrix P.
30. The method of aspect 29 or any other aspect herein wherein generating the weight-conversion offset vector \vec{γ} that forms part of the secondary facial component model based at least in part on the projection matrix P comprises:
   determining an input primary vertex subset mean vector \vec{μ}* of dimension 3p based on the primary face animation; and
   generating the weight-conversion offset vector \vec{γ} according to \vec{γ}=P(\vec{μ}*−\vec{ω}*), where \vec{ω}* is the combined primary subset mean vector of dimension 3p.
31. The method of aspect 30 or any other aspect herein wherein:
   the animation representation of the animation primary face geometry comprises an input primary face mean vector of dimension 3n where n represents a number of vertices of the primary face geometry; and
   determining the input primary vertex subset mean vector re based on the primary face animation comprises extracting, from the input primary face mean vector, the 3p elements which correspond to the subset of p primary face vertices.
32. The method of any one of aspects 29 to 31 wherein:
   the animation representation of the animation primary face geometry comprises, for each of the one or more frames of primary face animation, a plurality of k primary face animation blendshape weights;
   the animation representation of the animation secondary facial component geometry comprises, for each of the one or more frames of primary face animation, a plurality of q secondary facial component animation blendshape weights; and
   for each of the one or more frames of primary face animation, generating the corresponding frame of secondary facial component animation based on the frame of primary face animation and the secondary facial component model comprises:
      right multiplying the weight-conversion matrix C by the plurality of k primary face animation blendshape weights for the frame of primary face animation to yield, within an offset vector, the plurality of q secondary facial component animation blendshape weights for the corresponding frame of secondary facial component animation; and
      adding the weight-conversion offset vector \vec{γ} to a product of the right multiplication of the weight conversion matrix C by the plurality of k primary face animation blendshape weights for the frame of primary face animation to yield a vector comprising the plurality of q secondary facial component blendshape weights for the corresponding frame of secondary facial component animation.
33. The method of any one of aspects 28 and 30 wherein, for each of the one or more frames of primary face animation, generating, by the processor, the corresponding frame of secondary facial component animation based on the frame of primary face animation and the secondary facial component model comprises:
   reconstructing a three-dimensional vertex geometry (independent or offset from neutral) for the corresponding frame of secondary facial component animation according to \vec{a}=\vec{t}D+\vec{α} where \vec{t} is the vector comprising the plurality of q secondary facial component blendshape weights for the corresponding frame of secondary facial component animation, D is the secondary facial component basis matrix having dimensionality [q, 3m], \vec{α} is the secondary facial component mean vector having dimensionality 3m and \vec{a} is a vector comprising the 3m coordinates for the m secondary facial component vertices.
34. A method for training a secondary facial component model for use in computer-based facial animation wherein the secondary facial component model takes as input one or more frames of primary face animation, each of the one or more frames of primary face animation comprising an animation representation of an animation primary face geometry comprising geometric information for an animation plurality of primary face vertices and outputs, for each of the one or more frames of primary face animation, a corresponding frame of secondary facial component animation comprising an animation representation of an animation secondary facial component geometry comprising geometric information for an animation plurality of secondary facial component vertices wherein the secondary facial component geometry takes into account the primary face geometry, the method comprising:
   obtaining, at a processor, a plurality of frames of facial animation training data, the facial animation training data comprising, for each of the plurality of frames of facial animation training data:
      a training representation of a training primary face geometry comprising geometric information for a training plurality of n primary face vertices; and
      a corresponding training representation of a training secondary facial component geometry comprising geometric information for a training plurality of m secondary facial component vertices; and
the facial animation training data further comprising a subset index comprising indices of a subset p of the training plurality of n primary face vertices, where p≤n;
   training the secondary facial component model using the facial animation training data, wherein training the secondary facial component model using the facial animation training data comprises:
   performing a matrix decomposition (e.g. principal component analysis (PCA), independent component analysis (ICA), non-negative matrix factorization (NMF), any other suitable matrix decomposition or dimensionality reduction technique and/or the like) of a combined training matrix which includes:
      a plurality of f frames, each of the plurality of f frames comprising p primary face training vertex locations corresponding to the subset p of the plurality of n primary face vertices; and m secondary facial component training vertex locations;
to yield a combined matrix decomposition;
   generating the secondary facial component model based on the combined matrix decomposition.
35. The method of aspect 34 or any other aspect herein wherein obtaining the plurality of frames of facial animation training data comprises receiving the training representation of the training primary face geometry and the training representation of the training second facial component geometry from a computer-implemented animation rig.
36. The method of aspect 34 or any other aspect herein wherein obtaining the plurality of frames of facial animation training data comprises receiving the training representation of the training primary face geometry and the training representation of the training second facial component geometry at least in part from user input from an artist.
37. The method of any one of aspects 34 to 36 or any other aspect herein wherein the subset p of the training plurality of n primary face vertices are selected by a user as being relevant to the secondary facial component geometry.
38. The method of any one of aspects 34 to 36 or any other aspect herein comprising selecting the subset p from among the training plurality of n primary face vertices based on proximity (e.g. within a proximity threshold or selected as the most proximate p primary face vertices) to the secondary facial component geometry.
39. The method of any one of aspects 34 to 36 or any other aspect herein wherein the subset p of the training plurality of n primary face vertices are selected as being relevant to the secondary facial component geometry.
40. The method of any one of aspects 37 to 39 or any other aspect wherein obtaining the plurality of frames of facial animation training data comprises at least one of obtaining or converting the training representation of the training primary face geometry to, for each of the one or more frames of facial animation training data, locations of the training plurality of n primary face training vertices, each primary face training vertex location comprising 3 coordinates.
41. The method of any one of aspects 37 to 39 or any other aspect wherein obtaining the plurality of frames of facial animation training data comprises at least one of obtaining or converting the training representation of the training primary face geometry to, for each of the one or more frames of facial animation training data, locations for each of the subset of p primary face vertices, each subset vertex location comprising 3 coordinates.
42. The method of any one of aspects 40 or 41 or any other aspect herein wherein obtaining the plurality of frames of facial animation training data comprises at least one of obtaining or converting the training representation of the training secondary facial component geometry to, for each of the one or more frames of facial animation training data, locations of the plurality of m secondary facial component training vertices, each secondary facial component training vertex location comprising 3 coordinates.
43. The method of any one of aspects 34 to 42 or any other aspect herein wherein the combined matrix decomposition comprises:
   a combined basis matrix having dimensionality [q, 3(m+p)] where q is a number of blendshapes for the combined matrix decomposition;
   a combined mean vector having dimensionality 3(m+p).
44. The method of aspect 43 or any other aspect herein wherein generating the secondary facial component model based on the combined matrix decomposition comprises generating, from the combined matrix decomposition:
   a combined primary subset basis matrix having dimensionality [q, 3p] by extracting 3p vectors of length q (e.g. 3p columns) from the combined basis matrix which correspond to the subset p of primary face vertices; and
   a combined primary subset mean vector having dimensionality 3p by extracting 3p elements from the combined mean vector which correspond to the subset p of primary face vertices.
45. The method of aspect 44 or any other aspect herein wherein generating the secondary facial component model based on the combined matrix decomposition comprises generating, from the combined matrix decomposition:
   a secondary facial component basis matrix having dimensionality [q, 3m] by extracting 3m vectors of length q (e.g. 3m columns) from the combined basis matrix which correspond to the m secondary facial component vertices; and
   a secondary facial component mean vector having dimensionality 3m by extracting 3m elements from the combined mean vector which correspond to the m secondary facial component vertices.
46. The method of aspect 45 or any other aspect herein wherein generating the secondary facial component model based on the combined matrix decomposition comprises:
   generating a projection matrix P having dimensionality [q, 3p] based on the combined primary subset basis matrix, wherein the projection matrix P will project a vector of 3p positions or offsets of the subset p of primary face vertices into a corresponding set of weights for the combined primary subset basis matrix; and
   generating a weight-conversion matrix C that forms part of the secondary facial component model based at least in part on the projection matrix P.
47. The method of aspect 46 or any other aspect herein wherein generating the projection matrix P comprises selecting the projection matrix P that will minimize an error associated with converting the weights for the combined primary subset basis matrix back to the 3p positions or offsets of (e.g. reconstructing) the subset p of primary face vertices using the combined primary subset basis matrix.
48. The method of aspect 47 or any other aspect herein wherein generating the projection matrix P comprises selecting the projection matrix P that will minimize a least squares error associated with converting the weights for the combined primary subset basis matrix back to the 3p positions or offsets of (e.g. recontrusting) the subset of p primary face vertices using the combined primary subset basis matrix.
49. The method of any one of aspects 47 to 48 or any other aspect herein wherein generating the projection matrix P comprises calculating the projection matrix P according to P=(A^{T}A)⁻¹A^{T} where A^{T} is the combined primary subset basis matrix.
50. The method of any one of aspects 46 to 49 or any other aspect herein wherein generating the weight-conversion matrix C that forms part of the secondary facial component model based at least in part on the projection matrix P comprises:
   determining a matrix of primary vertex subset blendshapes V* having dimensionality [k, 3p] based on the primary face animation; and
   generating the weight-conversion matrix C according to C=PV*^{T}.
51. The method of aspect 50 or any other aspect herein wherein:
   the animation representation of the primary face geometry comprises a primary face blendshape matrix of dimensionality [k, 3n], where k represents a number of primary face blendshapes in a blendshape decomposition of the animation primary face geometry and n represents a number of vertices of the animation primary face geometry; and
   determining the matrix of primary vertex subset blendshapes V* based on the primary face animation comprises extracting, from the primary face blendshape matrix, the 3p vectors of length k (e.g. 3p columns) which correspond to the subset of p primary face vertices.
52. The method of any one of aspects 46 to 51 or any other aspect herein wherein generating the secondary facial component model based on the combined decomposition comprises generating a weight-conversion offset vector \vec{\vec{γ}} that forms part of the secondary facial component model based at least in part on the projection matrix P.
53. The method of aspect 52 or any other aspect herein wherein generating the weight-conversion offset vector \vec{\vec{γ}} that forms part of the secondary facial component model based at least in part on the projection matrix P comprises:
   determining an input primary vertex subset mean vector \vec{μ}* of dimension 3p based on the primary face animation; and
   generating the weight-conversion offset vector \vec{γ} according to \vec{γ}=P(\vec{μ}*−\vec{ω}*), where \vec{ω}* is the combined primary subset mean vector of dimension 3p.
54. The method of aspect 53 or any other aspect herein wherein:
   the animation representation of the animation primary face geometry comprises an input primary face mean vector of dimension 3n where n represents a number of vertices of the primary face geometry; and
   determining the input primary vertex subset mean vector re based on the primary face animation comprises extracting, from the input primary face mean vector, the 3p elements which correspond to the subset of p primary face vertices.
55. Method comprising features, combinations of features or sub-combinations of features of any of the preceding aspects.
56. A system comprising a processor configured, by suitable programing, to perform any of the methods of any of the preceding aspects.
57. A computer program product comprising a non-transitory medium which carries a set of computer-readable instructions which, when executed by a data processor, cause the data processor to execute any of the methods of the preceding aspects.
58. Methods having any new and inventive steps, acts, combination of steps and/or acts or sub-combination of steps and/or acts as described herein.
59. Apparatus having any new and inventive feature, combination of features, or sub-combination of features as described herein.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A method for generating one or more frames of computer-based facial animation, the method comprising:
obtaining, at a processor, a plurality of frames of facial animation training data, the facial animation training data comprising, for each of the plurality of frames of facial animation training data:
a training representation of a training primary face geometry comprising geometric information for a training plurality of primary face vertices; and
a corresponding training representation of a training secondary facial component geometry comprising geometric information for a training plurality of secondary facial component vertices; and
the facial animation training data further comprising a subset index comprising indices of a subset of the training plurality of primary face vertices;
training, by the processor, a secondary facial component model using the facial animation training data;
obtaining, at the processor, one or more frames of primary face animation, each of the one or more frames of primary face animation comprising an animation representation of an animation primary face geometry comprising geometric information for an animation plurality of primary face vertices;
for each of the one or more frames of primary face animation:
generating, by the processor, a corresponding frame of secondary facial component animation based on the frame of primary face animation and the secondary facial component model, the corresponding frame of the secondary facial component animation comprising an animation representation of an animation secondary facial component geometry comprising geometric information for an animation plurality of secondary facial component vertices wherein the secondary facial component geometry is based on the animation primary face geometry.

2. The method of claim 1 wherein the animation representation of the animation primary face geometry comprises, for each of the one or more frames of primary face animation, a plurality of k primary face animation blendshape weights.

3. The method of claim 2 wherein the animation representation of the animation secondary facial component geometry comprises, for each corresponding frame of secondary facial component animation, a plurality of q secondary facial component animation blendshape weights.

4. The method of claim 3 wherein the secondary facial component model comprises a weight-conversion matrix C and wherein, for each of the one or more frames of primary face animation, generating the corresponding frame of secondary facial component animation based on the frame of primary face animation and the secondary facial component model comprises right multiplying the weight conversion matrix C by the plurality of k primary face animation blendshape weights for the frame of primary face animation to yield, within an offset vector, the plurality of q secondary facial component animation blendshape weights for the corresponding frame of secondary facial component animation.

5. The method of claim 4 wherein the secondary facial component model comprises a weight-conversion offset vector \vec{γ} and wherein, for each of the one or more frames of primary face animation, generating the corresponding frame of secondary facial component animation based on the frame of primary face animation and the secondary facial component model comprises adding the weight-conversion offset vector \vec{γ} to a product of the right multiplication of the weight conversion matrix C by the plurality of k primary face animation blendshape weights for the frame of primary face animation to yield the plurality of q secondary facial component blendshape weights for the corresponding frame of secondary facial component animation.

6. The method of claim 1 comprising:
performing the steps of:
obtaining, at the processor, one or more frames of primary face animation; and,
for each of the one or more frames of primary face animation,
generating, by the processor, a corresponding frame of secondary facial component animation based on the frame of primary face animation and the secondary facial component model;
in real time.

7. The method of claim 1 comprising:
performing the steps of:
obtaining, at the processor, one or more frames of primary face animation; and,
for each of the one or more frames of primary face animation,
generating, by the processor, a corresponding frame of secondary facial component animation based on the frame of primary face animation and the secondary facial component model;
at a rate at least as fast as an animation frame rate for each of the one or more frames.

8. The method of claim 1 comprising:
performing the steps of:
obtaining, at the processor, one or more frames of primary face animation; and,
for each of the one or more frames of primary face animation,
generating, by the processor, a corresponding frame of secondary facial component animation based on the frame of primary face animation and the secondary facial component model;
at a rate of at least 15 frames per second.

9. The method of claim 1 comprising:
performing the steps of:
obtaining, at the processor, one or more frames of primary face animation; and,
for each of the one or more frames of primary face animation,
generating, by the processor, a corresponding frame of secondary facial component animation based on the frame of primary face animation and the secondary facial component model;
at a rate of at least 24 frames per second.

10. The method of claim 1 wherein obtaining the plurality of frames of facial animation training data comprises receiving the training representation of the training primary face geometry and the training representation of the training second facial component geometry from a computer-implemented animation rig.

11. The method of claim 1 wherein obtaining the plurality of frames of facial animation training data comprises receiving the training representation of the training primary face geometry and the training representation of the training second facial component geometry at least in part from user input.

12. The method of claim 1 wherein the subset index comprises indices of a subset of p primary face vertices (p≤n where n is a number of primary face vertices) that are selected by a user as being relevant to the secondary facial component geometry.

13. The method of claim 1 wherein the subset index comprises indices of a subset of p primary face vertices (p≤n where n is a number of primary face vertices) that are proximate (e.g. within a proximity threshold or selected as the most proximate p primary face vertices) to the secondary facial component geometry.

14. The method of claim 1 wherein the subset index comprises indices of a subset of p primary face vertices (p≤n where n is a number of primary face vertices) determined to be relevant to the secondary facial component geometry.

15. The method of claim 12 obtaining the plurality of frames of facial animation training data comprises at least one of obtaining or converting the training representation of the training primary face geometry to, for each of the one or more frames of facial animation training data, a plurality of n primary face training vertex locations, each primary face training vertex location comprising 3 coordinates.

16. The method of claim 12 wherein obtaining the plurality of frames of facial animation training data comprises at least one of obtaining or converting the training representation of the training primary face geometry to, for each of the one or more frames of facial animation training data, locations for each of the subset of p primary face vertices, each of the p primary face vertices comprising 3 coordinates.

17. The method of claim 15 wherein obtaining the plurality of frames of facial animation training data comprises at least one of obtaining or converting the training representation of the training secondary facial component geometry to, for each of the one or more frames of facial animation training data, a plurality of m secondary facial component training vertex locations, each secondary facial component training vertex location comprising 3 coordinates.

18. The method of claim 15 wherein training the secondary facial component model using the facial animation training data comprises:
performing a matrix decomposition (e.g. principal component analysis (PCA), independent component analysis (ICA), non-negative matrix factorization (NMF), any other suitable matrix decomposition or dimensionality reduction technique and/or the like) of a combined training matrix which includes:
a plurality of f frames, each of the plurality of f frames comprising p primary face training vertex locations corresponding to the subset of p primary face vertices; and m secondary facial component training vertex locations;
to yield a combined matrix decomposition;
generating the secondary facial component model based on the combined matrix decomposition.

19. The method of claim 18 wherein the combined matrix decomposition comprises:
a combined basis matrix having dimensionality [q, 3(m+p)] where q is a number of blendshapes for the combined matrix decomposition;
a combined mean vector having dimensionality 3(m+p).

20. The method of claim 19 wherein generating the secondary facial component model based on the combined matrix decomposition comprises generating, from the combined matrix decomposition:
a combined primary subset basis matrix having dimensionality [q, 3p] by extracting 3p vectors of length q (e.g. 3p columns) from the combined basis matrix which correspond to the subset of p primary face vertices; and
a combined primary subset mean vector having dimensionality 3p by extracting 3p elements from the combined mean vector which correspond to the subset of p primary face vertices.
